(19) United States
(12) Patent Application Publication
(10) Pub. No.: US 2014/0098190 A1
(43) Pub. Date: Apr. 10, 2014

(54) RECORDING APPARATUS, RECORDING METHOD, REPRODUCING APPARATUS, REPRODUCTION METHOD, PROGRAM, AND RECORDING/REPRODUCING APPARATUS

(71) Applicants: Motoki Kato, Kanagawa (JP); Toshiya Hamada, Saitama (JP)

(72) Inventors: Motoki Kato, Kanagawa (JP); Toshiya Hamada, Saitama (JP)

(73) Assignee: SONY CORPORATION, Minato-ku, Tokyo (JP)

(21) Appl. No.: 14/118,429

(22) PCT Filed: May 17, 2012
(86) PCT No.: PCT/JP2012/062638

§ 371 Date: Nov. 18, 2013

(30) Foreign Application Priority Data
May 26, 2011 (JP) 2011-118297

(51) Int. Cl. H04N 13/00

(52) U.S. Cl. CPC H04N 13/0048
USPC 348/43

(57) ABSTRACT

The present technology relates to a recording apparatus, a recording method, a reproducing apparatus, a reproducing method, a program, and a recording/reproducing apparatus that can provide reproduction control information to enable reproduction of a stream according to the reproduction capability. A recording apparatus according to a first aspect of the present technology includes a first generating unit that, as reproduction control information of a first video stream including a base stream obtained by encoding a predetermined image among a plurality of images having different viewing points and a dependent stream obtained by encoding other image, including a picture obtained by encoding a picture of the base stream as a reference image, generates information to which the same version information as version information of reproduction control information of a second video stream encoded using the same encoding method as an encoding method of the base stream is set and a recording control unit that records the first video stream and the reproduction control information of the first video stream on a recording medium.

### TECHNICAL FIELD

The present technology relates to a recording apparatus, a recording method, a reproducing apparatus, a reproduction method, a program, and a recording/reproducing apparatus that can provide reproduction control information to enable reproduction of a stream according to the reproduction capability.

### BACKGROUND ART

Recently, 3D content including images to be three-dimensionally viewed has attracted attention. Video data of the 3D content includes data of an image (L image) for a left eye and an image (R image) for a right eye. In a subject imaged in the L image and a subject imaged in the R image, there are deviations corresponding to parallaxes.

For example, the L image and the R image to which the parallaxes are set are alternately displayed to be viewed by the left eye and the right eye of a user who wears active shutter glasses, respectively, so that the subject can be three-dimensionally recognized.

As a method of encoding a stereoscopic image including the L image and the R image, there is MPEG-4 MVC. A method of encoding a stereoscopic image imaged by a home video camera with the MPEG-4 MVC and enabling the stereoscopic image to be recorded on a BD (Blu-ray Disc (trademark)) or the like has been examined.

### CITATION LIST

### Patent Documents

Patent Document 1: Japanese Patent Application Laid-Open No. 2002-158972
Patent Document 2: Japanese Patent Application Laid-Open No. 2010-263614

### SUMMARY OF THE INVENTION

### Problems to be Solved by the Invention

Meanwhile, there is BDAV (BD Audio Visual) as an application format of the BD.

How to record encoding data of the MPEG-4 MVC on the BD with the application format of the BDAV is not defined. In addition, how to reproduce the encoding data of the MPEG-4 MVC recorded on the BD is not defined.

The present technology has been made in view of the above circumstances and can provide reproduction control information to enable reproduction of a stream according to the reproduction capability.

### Solutions to Problems

A recording apparatus according to a first aspect of the present technology includes: a first generating unit that, as reproduction control information of a first video stream including a base stream obtained by encoding a predetermined image among a plurality of images having different viewing points and a dependent stream obtained by encoding other image, including a picture obtained by encoding a picture of the base stream as a reference image, generates information to which the same version information as version information of reproduction control information of a second video stream encoded using the same encoding method as an encoding method of the base stream is set; and a recording control unit that records the first video stream and the reproduction control information of the first video stream on a recording medium.

The version information may be predetermined digits and may be characters or symbols of a predetermined number.

The recording media include an optical disk inserted into a drive of the recording apparatus, a memory card, a flash module embedded in the recording apparatus, and an HDD (Hard Disk Drive). Recording media of an apparatus connected to the recording apparatus through a network or recording media of an apparatus connected to the recording apparatus through a cable may be used for recording data.

The first video stream may be an MPEG-4 MVC video stream, and the second video stream may be an MPEG-4 AVC video stream.

The recording apparatus may further include a second generating unit that generates a file including encoding information showing an encoding method of each of the base stream and the dependent stream. In this case, the recording control unit may further record the file on the recording medium.

The reproduction control information may be a PlayList file, and the file may be a Clip Information file that corresponds to a transport stream file including the MPEG-4 MVC video stream.

The second generating unit may set two video information including the encoding information to ProgramInfo( ) of the Clip Information file, set a value showing the encoding method of the base stream to the encoding information of the first video information, and set a value showing the encoding method of the dependent stream to the encoding information of the second video information.

The second generating unit may set a value showing that the base stream is an MPEG-4 AVC video stream or an MPEG-4 MVC Base view video stream, as the value showing the encoding method of the base stream, and set a value showing that the dependent stream is an MPEG-4 MVC Dependent view video stream, as the value showing the encoding method of the dependent stream.

The second generating unit may set the same information as version information of the PlayList file as version information of the Clip Information file.

The recording apparatus may further include an encoding unit that encodes the plurality of images with MPEG-4 MVC and generates the base stream and the dependent stream.

A reproducing apparatus according to a second aspect of the present technology includes: a control unit that, according to a first video stream including a base stream obtained by encoding a predetermined image among a plurality of images having different viewing points and a dependent stream obtained by encoding other image, including a picture obtained by encoding a picture of the base stream as a reference image, and reproduction control information of the first video stream to which the same version information as version information of reproduction control information of a second video stream encoded using the same encoding method as an encoding method of the base stream is set and which is recorded on a recording medium, controls decoding of the first video stream; and a decoding unit that decodes only the base stream or decodes both the base stream and the dependent stream, according to the control from the control unit.

The decoding unit that can decode the base stream and the dependent stream may decode the base stream and the dependent stream and output the predetermined image and other image.

The decoding unit that cannot decode the dependent stream may decode only the base stream and output the predetermined image.

A recording/reproducing apparatus according to a third aspect of the present technology includes: a generating unit that, as reproduction control information of a first video stream including a base stream obtained by encoding a predetermined image among a plurality of images having different viewing points and a dependent stream obtained by encoding other image, including a picture obtained by encoding a picture of the base stream as a reference image, generates information to which the same version information as version information of reproduction control information of a second video stream encoded using the same encoding method as an encoding method of the base stream is set; a recording control unit that records the first video stream and the reproduction control information of the first video stream on a recording medium; a control unit that controls decoding of the first video stream, according to the reproduction control information of the first video stream recorded on the recording medium; and a decoding unit that decodes only the base stream or decodes both the base stream and the dependent stream, according to the control from the control unit.

### Effects of the Invention

According to the present technology, reproduction control information to enable reproduction of a stream according to the reproduction capability can be provided.

### BRIEF DESCRIPTION OF DRAWINGS

FIG. 1 is a diagram illustrating a configuration example of a recording system.

FIG. 2 is a diagram illustrating MPEG-4 MVC.

FIG. 3 is a diagram illustrating a structure of an application format of an optical disk.

FIG. 4 is a diagram illustrating a directory structure of an optical disk.

FIG. 5 is a diagram illustrating syntax of a PlayList file.

FIG. 6 is a diagram illustrating syntax of PlayList( ) of FIG. 5.

FIG. 7 is a diagram illustrating syntax of PlayItem( ) of FIG. 6.

FIG. 8 is a diagram illustrating syntax of a Clip information file.

FIG. 9 is a diagram illustrating syntax of ProgramInfo( ) of FIG. 8.

FIG. 10 is a diagram illustrating stream_coding_type.

FIG. 11 is a block diagram illustrating a configuration example of a 3D correspondence recording apparatus.

FIG. 12 is a flowchart illustrating processing of a 3D correspondence recording apparatus that records a PlayList file for MPEG-4 MVC video.

FIG. 13 is a diagram illustrating a specific example of a PlayList file for MPEG-4 MVC video.

FIG. 14 is a diagram illustrating a specific example of a Clip Information file.

FIG. 15 is a diagram illustrating a specific example of ProgramInfo( ) of FIG. 14.

FIG. 16 is a diagram illustrating a configuration example of another recording system.

FIG. 17 is a block diagram illustrating a configuration example of a 2D correspondence recording apparatus.

FIG. 18 is a flowchart illustrating processing of a 2D correspondence recording apparatus that records a PlayList file for MPEG-4 AVC video.

FIG. 19 is a diagram illustrating a specific example of a PlayList file for MPEG-4 AVC video.

FIG. 20 is a diagram illustrating a specific example of a Clip Information file.

FIG. 21 is a diagram illustrating a specific example of ProgramInfo( ) of FIG. 20.

FIG. 22 is a diagram illustrating a configuration example of a reproduction system.

FIG. 23 is a block diagram illustrating a configuration example of a 3D correspondence reproducing apparatus.

FIG. 24 is a flowchart illustrating processing of a 3D correspondence reproducing apparatus that reproduces a PlayList file for MPEG-4 MVC video.

FIG. 25 is a diagram illustrating switching of an output of a 3D correspondence reproducing apparatus.

FIG. 26 is a diagram illustrating another configuration example of a reproduction system.

FIG. 27 is a block diagram illustrating a configuration example of a 2D correspondence reproducing apparatus.

FIG. 28 is a flowchart illustrating processing of a 2D correspondence reproducing apparatus that reproduces a PlayList file for MPEG-4 AVC video.

FIG. 29 is a flowchart illustrating processing of a 2D correspondence reproducing apparatus that reproduces a PlayList file for MPEG-4 MVC video.

FIG. 30 is a diagram illustrating an output of a 2D correspondence reproducing apparatus.

FIG. 31 is a diagram illustrating a 3D correspondence recording/reproducing apparatus.

FIG. 32 is a diagram illustrating a 2D correspondence recording/reproducing apparatus.

FIG. 33 is a block diagram illustrating a configuration example of a computer.

### MODE FOR CARRYING OUT THE INVENTION

Hereinafter, embodiments to carry out the present technology will be described. The following description will be made in the order described below.

### 1. Example of Recording Side

1-1. With Respect to 3D Correspondence Recording Apparatus

1-2. With Respect to 2D Correspondence Recording Apparatus

### 2. Example of Reproducing Side

2-1. With Respect to 3D Correspondence Reproducing Apparatus

2-2. With Respect to 2D Correspondence Reproducing Apparatus

### 3. Modification

### 1. Example of Recording Side

<1-1. With Respect to 3D Correspondence Recording Apparatus>

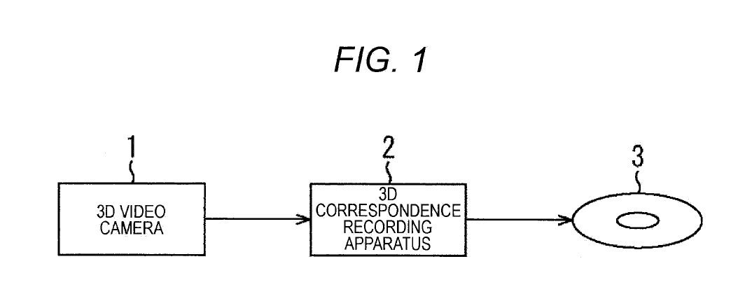

FIG. 1 is a diagram illustrating a configuration example of a recording system.

The recording system of FIG. 1 includes a 3D video camera 1 and a 3D correspondence recording apparatus 2. An optical disk 3 is inserted into a drive of the 3D correspondence recording apparatus 2. The optical disk 3 is, for example, a BD.

The 3D video camera 1 is a 3D correspondence video camera that can image a stereoscopic moving image. On a front surface of the 3D video camera 1, lenses are provided at right and left positions toward a subject from the 3D video camera 1, respectively. In the 3D video camera 1, a camera for a right eye to generate an R image on the basis of light taken by the right lens and a camera for a left eye to generate an L image on the basis of light taken by the left lens are provided. The camera for the right eye and the camera for the left eye may be provided as cameras of separated casings.

Data of an imaged stereoscopic image is recorded on a recording medium in the 3D video camera 1. The data of the stereoscopic image that is recorded on the recording medium is transmitted to the 3D correspondence recording apparatus 2, when the 3D video camera 1 is connected to the 3D correspondence recording apparatus 2 through a USB (Universal Serial Bus) cable.

The 3D correspondence recording apparatus 2 is a 3D correspondence recording apparatus that can record the data of the stereoscopic image supplied from the 3D video camera 1 on the optical disk 3. The 3D correspondence recording apparatus 2 encodes the stereoscopic image supplied from the 3D video camera 1 with MPEG-4 MVC (Multi-view Video coding).

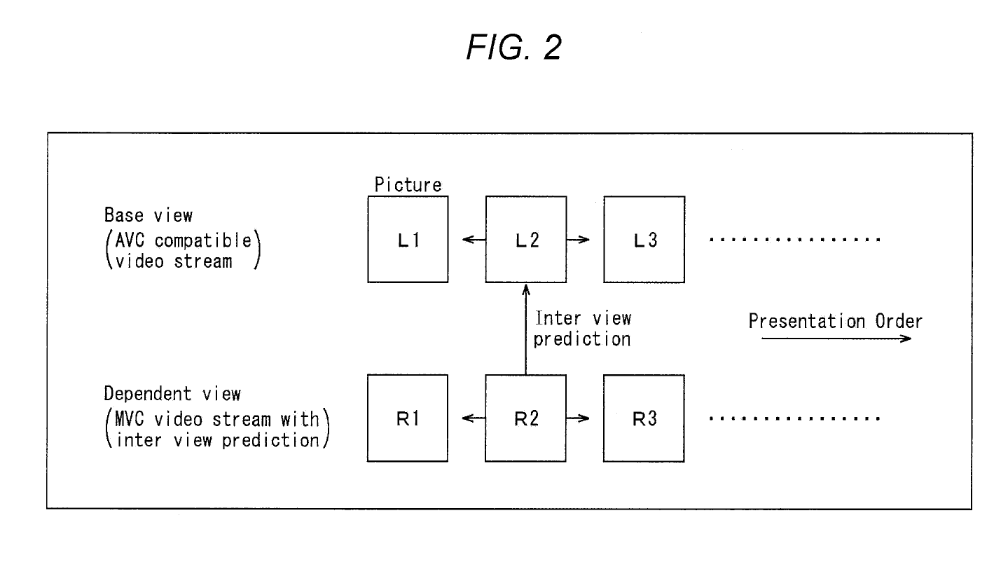

Here, the MPEG-4 MVC will be described with reference to FIG. 2.

An MPEG-4 MVC video stream includes one video stream that is called a Base view video stream and one video stream that is called a Dependent view video stream.

The Base view video stream is a video stream that is obtained by encoding the L image of the L and R images with MPEG-4 AVC. As illustrated by a vertical arrow of FIG. 2, in a picture of a Base view, prediction encoding using a picture of other view as a reference image is not permitted.

Meanwhile, in a picture of a Dependent view, prediction encoding using the picture of the Base view as a reference image is permitted. For example, when the L image is set to the Base view and the R image is set to the Dependent view and encoding is performed, an amount of data of a Dependent view video stream to be a video stream of the R image obtained as a result of the encoding becomes smaller than an amount of data of a Base view video stream to be a video stream of the L image.

Because encoding in the MPEG-4 AVC is performed, prediction encoding of a time direction is performed with respect to the picture of the Base view, as illustrated by a horizontal arrow of FIG. 2. In addition, prediction between views and the prediction encoding of the time direction are performed with respect to the picture of the Dependent view. In order to decode the picture of the Dependent view, decoding of the picture of the Base view used as the reference destination at the time of the encoding and corresponding to the picture of the Dependent view needs to be first terminated.

Only the Base view video stream included in the MPEG-4 MVC video stream is reproduced alone, so that display of a 2D image (L image) is enabled. In addition, both the video streams of the Base view video stream and the Dependent view video stream are reproduced, so that display of a stereoscopic image is enabled.

The 3D correspondence recording apparatus 2 of FIG. 1 records the MPEG-4 MVC video stream obtained by encoding the stereoscopic image on the optical disk 3 together with a PlayList file or the like. The optical disk 3 on which the MPEG-4 MVC video stream or the like is recorded is provided to a reproducing apparatus.

The PlayList file that is recorded on the optical disk 3 together with the MPEG-4 MVC video stream is used for reproducing the MPEG-4 MVC video stream. Hereinafter, the PlayList file that is recorded together with the MPEG-4 MVC video stream is appropriately called a PlayList file for MPEG-4 MVC video.

Likewise, a PlayList file that is recorded on the optical disk 3 together with an MPEG-4 AVC video stream to be described below and is used for reproducing the MPEG-4 AVC video stream is appropriately called a PlayList file for MPEG-4 AVC video.

### [Management Structure of Data]

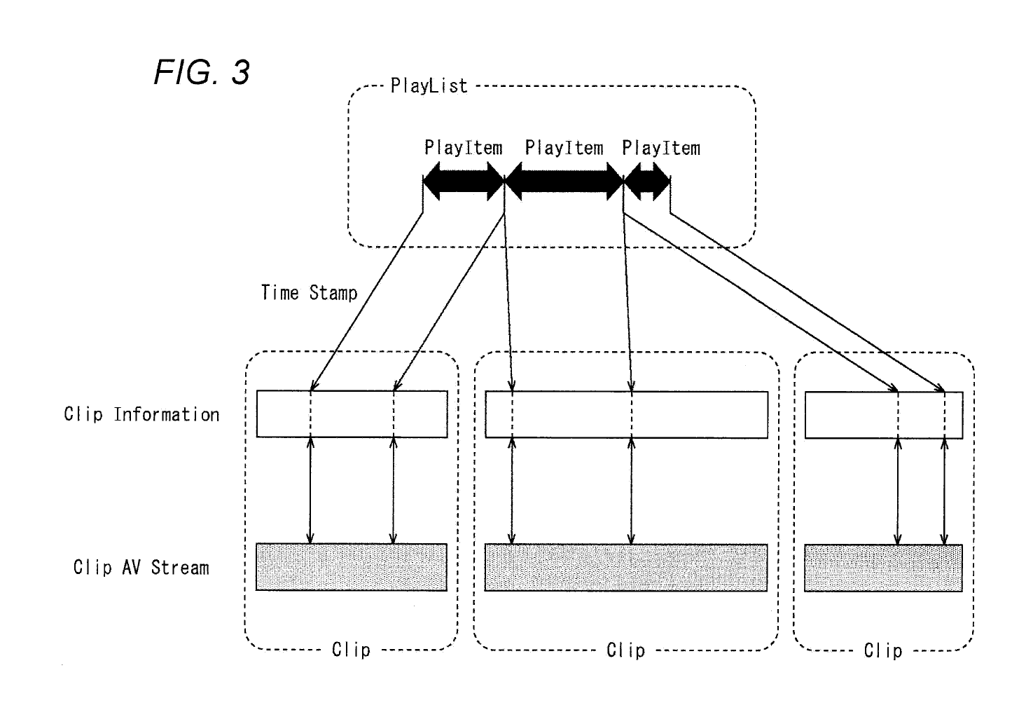

A recording format of the video stream will be described. FIG. 3 is a diagram illustrating a structure of an application format of the optical disk 3.

The application format has two layers of a PlayList and a Clip to manage an AV stream. Here, a pair of one AV stream and attached information thereof is called as the Clip. The AV stream constituting the Clip is called a Clip AV stream and attached information thereof is called Clip Information.

The Clip AV stream is developed on a time axis and an entry point in the Clip is mainly designated by a time base. The Clip Information is used to find an address to start reading of data in the Clip AV stream.

The PlayList is reproduction control information that is used to select a reproduction section of the Clip. One reproduction section of the Clip is called a PlayItem and the PlayItem is represented by a pair of an IN point and an OUT point on the time axis. The PlayList includes a plurality of PlayItems.

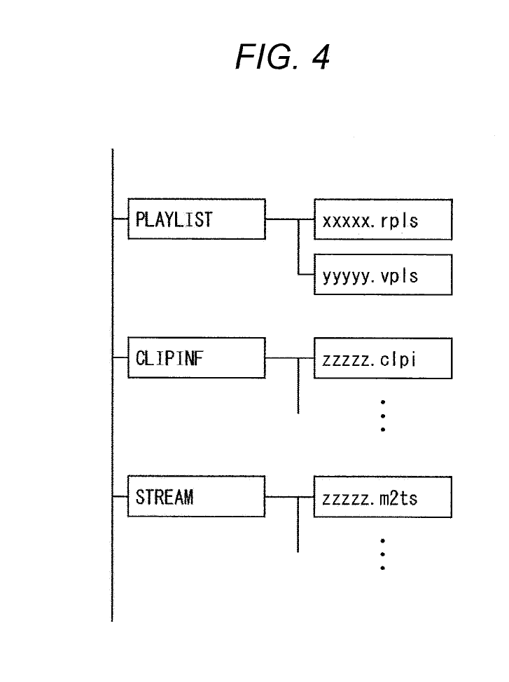

FIG. 4 is a diagram illustrating a directory structure of the optical disk 3.

In directories of the optical disk 3, a “PLAYLIST” directory, a “CLIPINF” directory, and a “STREAM” directory are included.

In the “PLAYLIST” directory, PlayList files are stored. The PlayList file has an extension of “rpls” or “vpls”. In an example of FIG. 4, a PlayList file to which a file name of “xxxxx.rpls” is set and a PlayList file to which a file name of “yyyyy.vpls” is set are stored.

In the “CLIPINF” directory, a Clip Information file corresponding to each transport stream file is stored. The Clip Information file has an extension of “clpi”. In the example of FIG. 4, a Clip Information file of “zzzzz.clpi” is stored.

In the “STREAM” directory, a transport stream file to be a file of an AV stream is stored. The transport stream file has an extension of “m2ts”. In the example of FIG. 4, a transport stream file of “zzzzz.m2ts” is stored.

If the file name includes a body portion and an extension, five figures are set equally to a body portion of a file name of a certain Clip Information file and a body portion of a file name of a corresponding transport stream file. The transport stream file of “zzzzz.m2ts” of FIG. 4 is a file that corresponds to the Clip Information file of “zzzzz.clpi”.

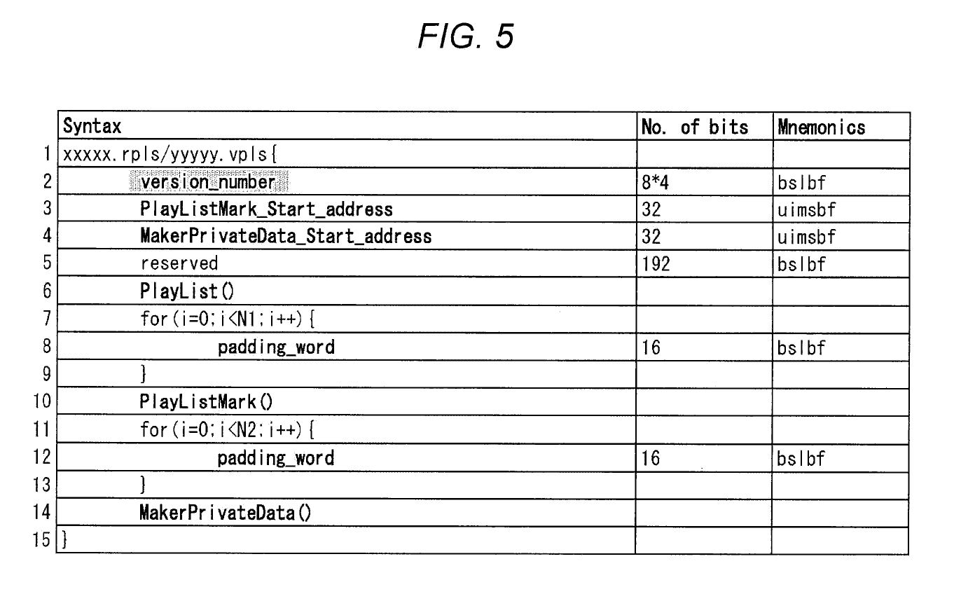

FIG. 5 is a diagram illustrating syntax of a PlayList file. A PlayList file that has the extension of “rpls” in a file name and a PlayList file that has the extension of “vpls” in a file name basically include the same information. Hereinafter, main information included in the PlayList file and the Clip Information file will be described.

A version_number of a second row shows a version number of a PlayList file. “0110” that is equal to a version_number of a PlayList file for MPEG-4 AVC video generated by the 2D correspondence recording apparatus 102 of FIG. 16 to be described below is set to version_number of a PlayList file for MPEG-4 MVC video generated by the 3D correspondence recording apparatus 2.

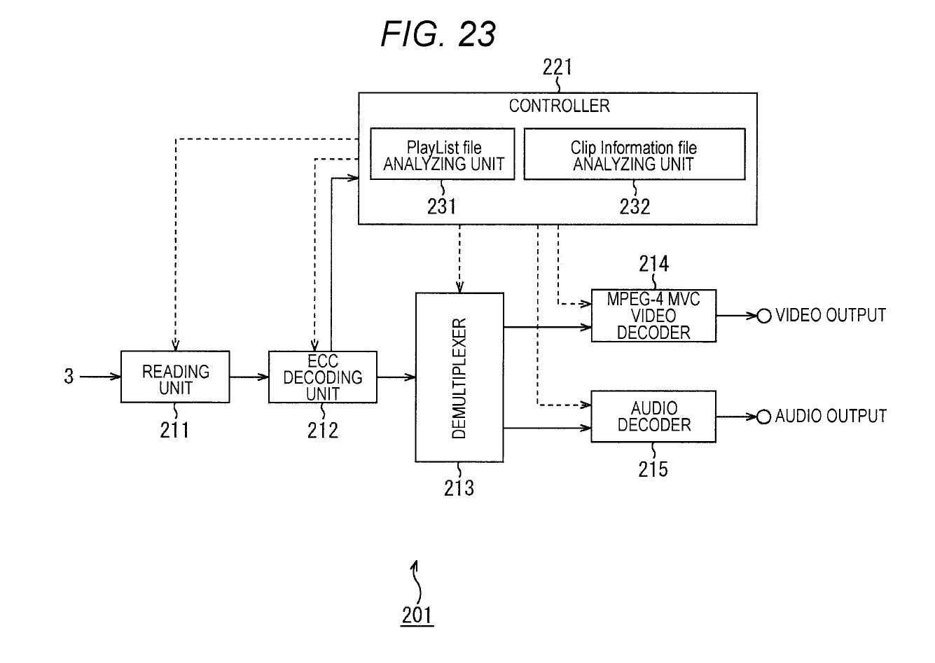

Information other than the version_number that is included in the PlayList file has the same meaning as information illustrated in FIG. 23 of Japanese Patent Application Laid-Open No. 2001-158972.

That is, a PlayList_start_address of a third row shows a start address of a PlayList( ) in a unit of the number of relative bytes from a byte of a head of the PlayList file.

A MakerPrivateData_Start_address of a fourth row shows a start address of MakerPrivateData( ) in a unit of the number of relative bytes from a byte of a head of the PlayList file.

In a PlayList( ) of a sixth row, information regarding a PlayItem is included.

In a PlayListMark( ) of a tenth row, information regarding designation information (mark) such as a starting point and a scene change point of a program is included.

In MakerPrivateData( ) of a fourteenth row, predetermined PrivateData is included.

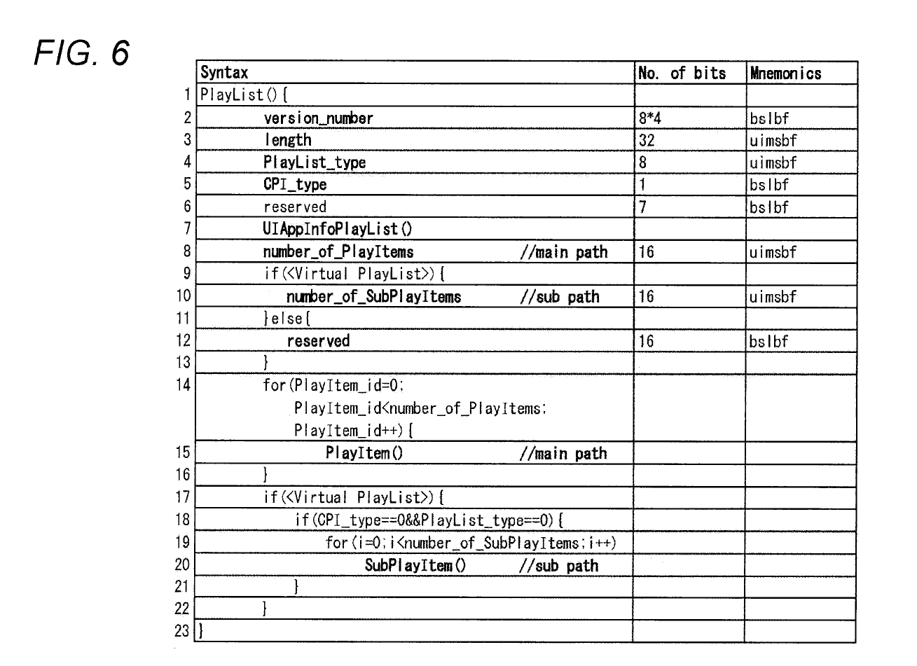

FIG. 6 is a diagram illustrating syntax of the PlayList( ) of FIG. 5.

A version_number of a second row shows a version number of the PlayList( ).

A length of a third row shows the number of bytes from the direct back of a length field to the last of the PlayList( ).

A PlayList_type of a fourth row shows a type of a PlayList. As the type of the PlayList, there are a PlayList for AV recording and a PlayList for audio recording.

A CPI_type of a fifth row is a flag of one bit and shows a CPI_type of a Clip that is referred to by a PlayItem( ) and a SubPlayItem( ).

A number_of_PlayItems of an eighth row shows the number of PlayItems in the PlayList( ).

A PlayItem( ) of a fifteenth row is information regarding a PlayItem. A PlayItem_id is allocated to each PlayItem.

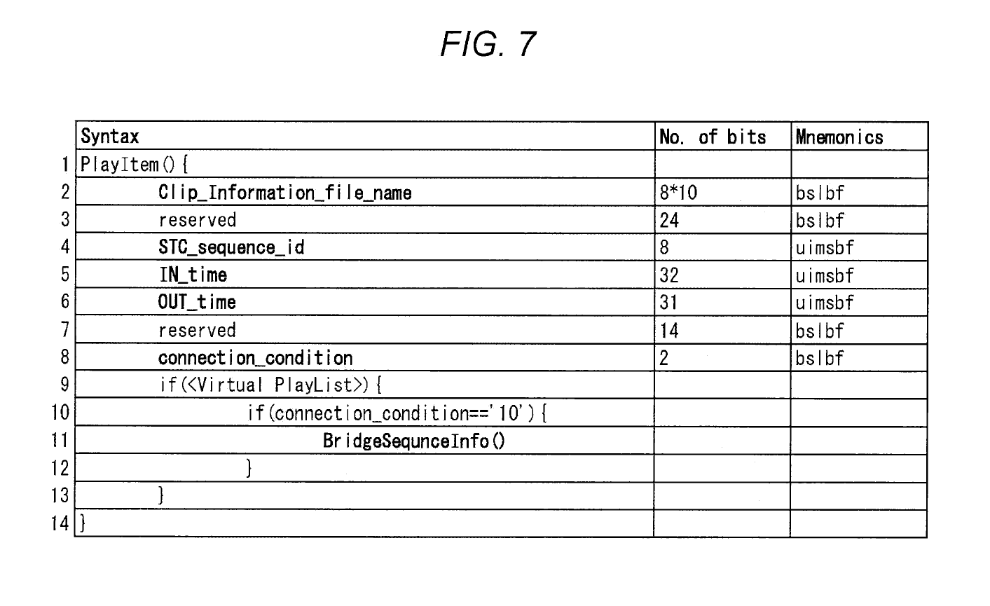

FIG. 7 is a diagram illustrating syntax of the PlayItem( ) of FIG. 6.

A Clip_Information_file_name of a second row shows five figures that are included in a body portion of a file name of a Clip Information file. As described above, five digits are set equally to a body portion of a file name of a certain Clip Information file and a body portion of a file name of a corresponding transport stream file. A file name of a Clip Information file set as a read target and a file name of a corresponding transport stream file can be specified from the Clip_Information_file_name included in the PlayItem( ).

An IN_time of a fifth row shows a starting time of a PlayItem.

An OUT_time of a sixth row shows an ending time of the PlayItem. A reproduction section can be specified from the IN_time and the OUT_time.

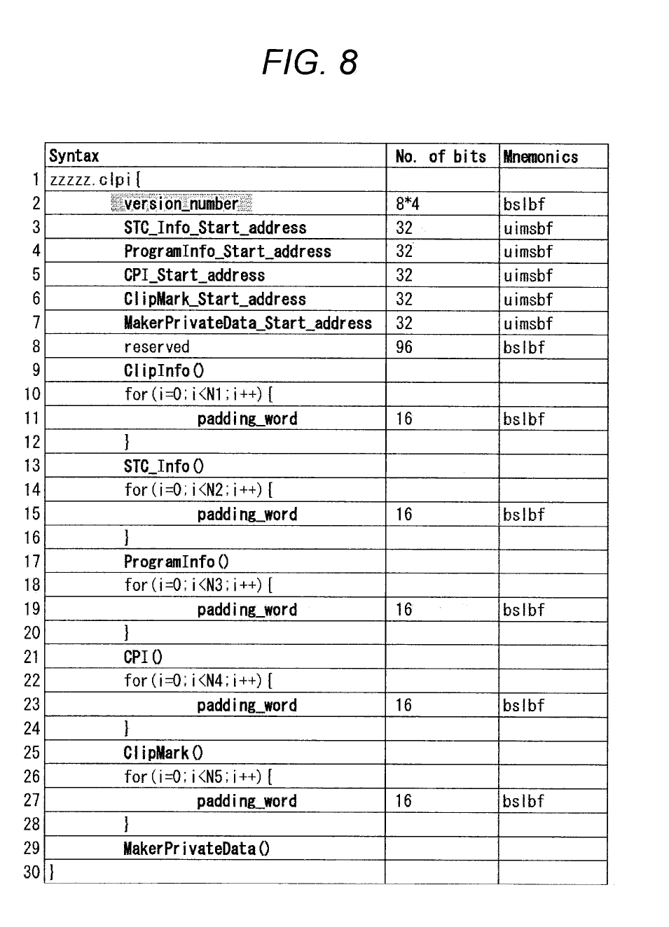

FIG. 8 is a diagram illustrating syntax of a Clip_information file.

A file name of the Clip_information file of FIG. 8 is “zzzzz.clpi” that includes “zzzzz” specified from the Clip_Information_file_name.

A version_number of a second row shows a version number of the Clip information file. “0110” that is equal to the version_number of the Playlist file is set to a version_number of the Clip information file.

A ProgramInfo_Start_address of a fourth row shows a start address of ProgramInfo( ) in a unit of the number of relative bytes from a byte of a head of the Clip information file.

In ClipInfo( ) of a ninth row, a version_number showing a version number of the ClipInfo( ), a Clip_stream_type showing a type of a transport stream file corresponding to the Clip Information file, and a TS_recording_rate showing a bit rate of a transport stream are included.

In ProgramInfo( ) of a seventeenth row, information such as a PID of a transport packet to store a video stream set as a reproduction target and a PID of a transport packet to store an audio stream is included.

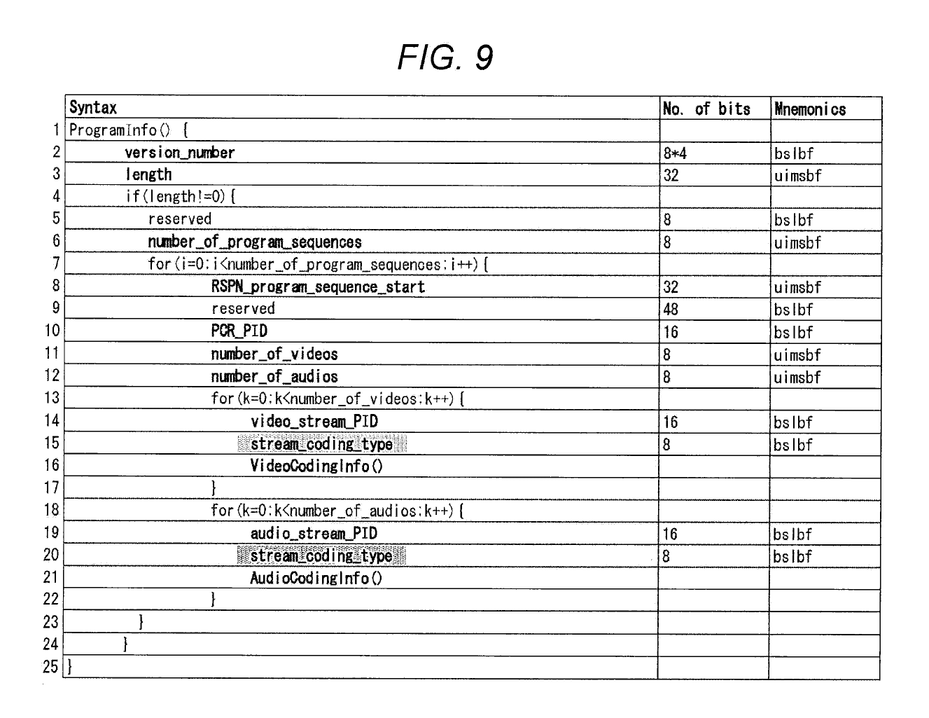

FIG. 9 is a diagram illustrating syntax of the ProgramInfo( ) of FIG. 8.

A version_number of a second row shows a version number of the ProgramInfo( ).

A length of a third row shows the number of bytes from the direct back of a length field to the final of the ProgramInfo( ).

A number_of_videos of an eleventh row shows the number of video information that is included in the ProgramInfo( ). The video information includes a video_stream_PID of a fourteenth row, a stream_coding_type of a fifteenth row, and VideoCodingInfo( ) of a sixteenth row.

Because the PlayList file generated by the 3D correspondence recording apparatus 2 is reproduction control information of the Base view video stream and the Dependent view video stream included in the MPEG-4 MVC video stream, a value of 2 is set to the number_of_videos.

Meanwhile, because the PlayList generated by the 2D correspondence recording apparatus 102 of FIG. 16 is reproduction control information of the MPEG-4 AVC video stream, a value of 1 is set to the number_of_videos.

A number_of_audios of a twelfth row shows the number of audio information that is included in the ProgramInfo( ). The audio information includes an audio_stream_PID of a nineteenth row, a stream_coding_type of a twentieth row, and AudioCodingInfo( ) of a twenty-first row.

A video_stream_PID of a fourteenth row shows a PID of a transport packet to store a valid video stream in a program_sequence.

A stream_coding_type of a fifteenth row shows a method of encoding a video stream referred to by the video_stream_PID.

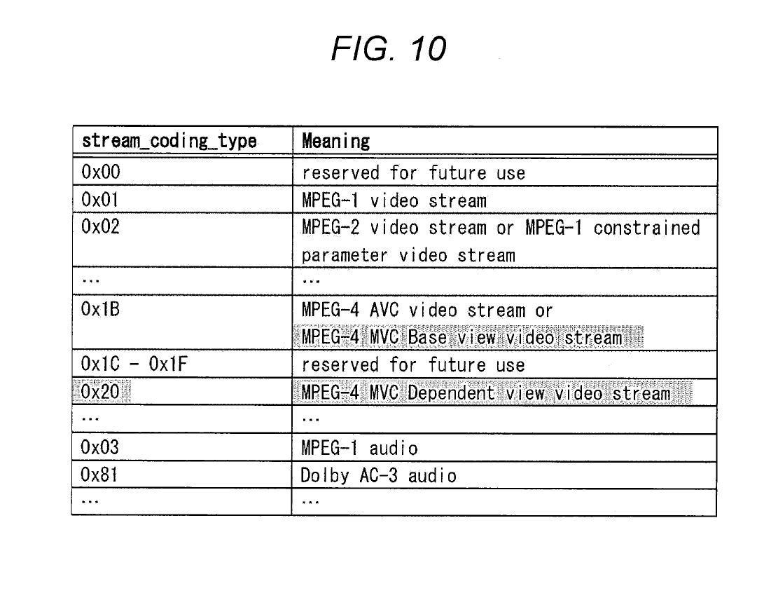

FIG. 10 is a diagram illustrating the stream_coding_type.

As illustrated in FIG. 10, when a value of the stream_coding_type is 0x1B, it shows that the video stream referred to by the video_stream_PID is the MPEG-4 AVC video stream or the MPEG-4 MVC Base view video stream.

In addition, when the value of the stream_coding_type is 0x20, it shows that the video stream referred to by the video_stream_PID is the MPEG-4 MVC Dependent view video stream.

In VideoCodingInfo( ) of a sixteenth row of FIG. 9, information regarding content of the video stream referred to by the video_stream_PID is included.

An audio_stream_PID of a nineteenth row shows a PID of a transport packet to store a valid audio stream in a program_sequence.

A stream_coding_type of a twentieth row shows a method of encoding an audio stream referred to by the audio_stream_PID.

In AudioCodingInfo( ) of a twenty-first row, information regarding content of a video stream referred to by the audio_stream_PID is included.

In the 3D correspondence recording apparatus 2, the PlayList file for the MPEG-4 MVC video including the information described above and the Clip Information file corresponding to the transport stream file including the MPEG-4 MVC video stream are generated. In addition, the PlayList file for the MPEG-4 MVC video and the Clip Information file are recorded on the optical disk 3 together with the transport stream file including the MPEG-4 MVC video stream.

### [Configuration of 3D Correspondence Recording Apparatus]

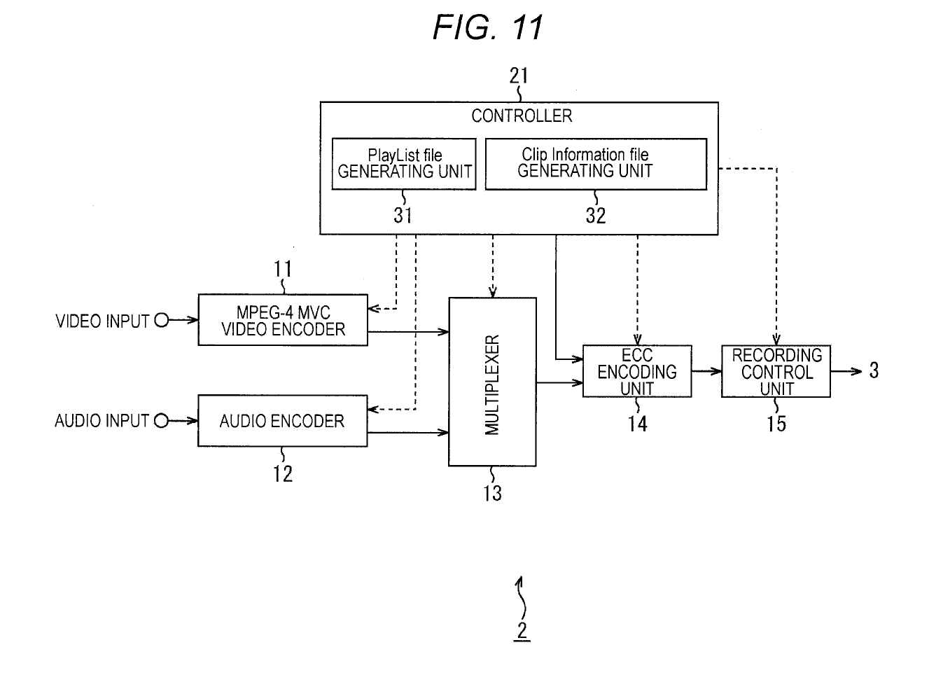

FIG. 11 is a block diagram illustrating a configuration example of the 3D correspondence recording apparatus 2.

The 3D correspondence recording apparatus 2 includes an MPEG-4 MVC video encoder 11, an audio encoder 12, a multiplexer 13, an ECC encoding unit 14, a recording control unit 15, and a controller 21. A stereoscopic image input from the 3D video camera 1 is supplied to the MPEG-4 MVC video encoder 11 and the audio data is supplied to the audio encoder 12.

The MPEG-4 MVC video encoder 11 encodes the L image imaged by the 3D video camera 1 with the MPEG-4 AVC and generates the Base view video stream. In addition, the MPEG-4 MVC video encoder 11 encodes the R image imaged by the 3D video camera 1 using the L image as the reference image and generates the Dependent view video stream. The MPEG-4 MVC video encoder 11 outputs the MPEG-4 MVC video stream including the Base view video stream and the Dependent view video stream to the multiplexer 13.

The audio encoder 12 encodes the audio data supplied from the 3D video camera 1 using a predetermined encoding method and outputs a video stream an audio stream obtained by the encoding to the multiplexer 13.

The multiplexer 13 multiplexes the MPEG-4 MVC video stream supplied from the MPEG-4 MVC video encoder 11 and the audio stream supplied from the audio encoder 12. The multiplexer 13 outputs a transport stream file to be a file of an AV stream obtained by the multiplexing to the ECC encoding unit 14.

The ECC encoding unit 14 performs error correction coding with respect to the transport stream file supplied from the multiplexer 13 and outputs the transport stream file after the error correction coding to the recording control unit 15. In addition, the ECC encoding unit 14 performs the error correction coding with respect to the PlayList file for the MPEG-4 MVC video and the Clip Information file supplied from the controller 21 and outputs the PlayList file and the Clip Information file after the error correction coding to the recording control unit 15.

The recording control unit 15 records the transport stream file, the PlayList file for the MPEG-4 MVC video, and the Clip Information file supplied from the ECC encoding unit 14 on the optical disk 3.

The controller 21 includes a CPU (Central Processing Unit), a ROM (Read Only Memory), and a RAM (Random Access Memory) and controls an entire operation of the 3D correspondence recording apparatus 2 according to a predetermined program. The program is executed, so that a PlayList file generating unit 31 and a Clip Information file generating unit 32 are realized in the controller 21.

The PlayList file generating unit 31 refers to the MPEG-4 MVC video stream generated by the MPEG-4 MVC video encoder 11 and generates the PlayList file for the MPEG-4 MVC video. Each information of FIGS. 5 to 7 is included in the PlayList file for the MPEG-4 MVC video. The PlayList file generating unit 31 outputs the generated PlayList file for the MPEG-4 MVC video to the ECC encoding unit 14.

The Clip Information file generating unit 32 refers to the MPEG-4 MVC video stream generated by the MPEG-4 MVC video encoder 11 and generates the Clip Information file corresponding to the transport stream file including the MPEG-4 MVC video stream. Each information of FIGS. 8 and 9 is included in the Clip Information file corresponding to the transport stream file including the MPEG-4 MVC video stream. The Clip Information file generating unit 32 outputs the generated Clip Information file to the ECC encoding unit 14.

The L and R images may be encoded with the MPEG-4 MVC in the 3D video camera 1 and the MPEG-4 MVC video stream may be input from the 3D video camera 1. In this case, the MPEG-4 MVC video stream that is input from the 3D video camera 1 is supplied to the multiplexer 13 as it is. The MPEG-4 MVC video stream that is supplied to the multiplexer 13 is processed in each unit, similar to the MPEG-4 MVC video stream generated by the MPEG-4 MVC video encoder 11, and is then recorded on the optical disk 3.

### [Operation of 3D Correspondence Recording Apparatus]

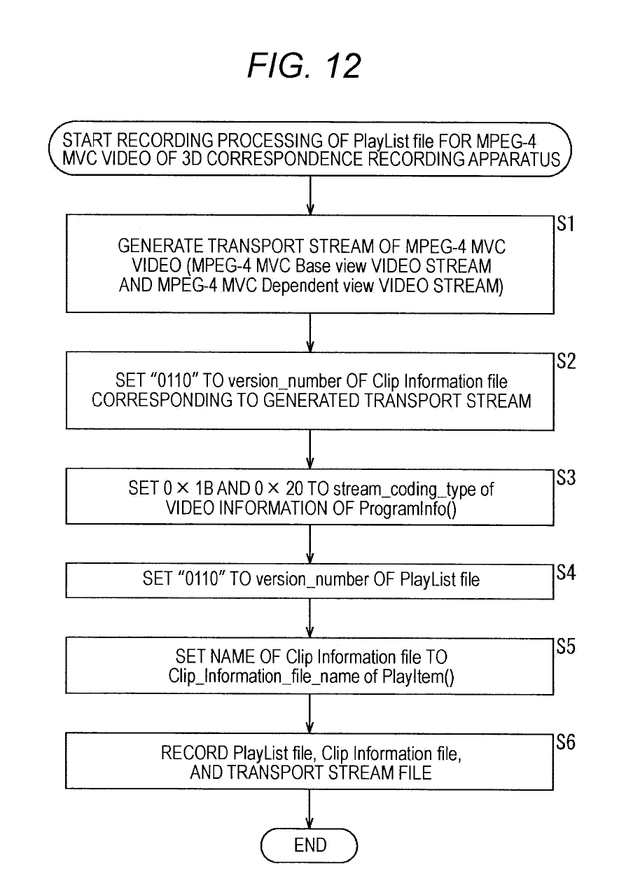

Here, processing of the 3D correspondence recording apparatus 2 that records the PlayList file for the MPEG-4 MVC video will be described with reference to a flowchart of FIG. 12. The processing of FIG. 12 starts when the L and R images are input from the 3D video camera 1.

Processing of the playlist file, the Clip Information file, and the video are mainly described. However, processing is executed with respect to the audio, as described above. This is applicable to description of the other flowcharts.

In step S1, the MPEG-4 MVC video encoder 11 encodes the L and R images input from the 3D video camera 1 with the MPEG-4 MVC and generates the MPEG-4 MVC video stream including the Base view video stream and the Dependent view video stream. By performing multiplexing with the audio stream, the transport stream file including the MPEG-4 MVC video stream is generated.

In step S2, the Clip Information file generating unit 32 sets the file name of the Clip Information file corresponding to the generated transport stream file and sets “0110” to the version_number (FIG. 8).

In step S3, the Clip Information file generating unit 32 sets the value of 2 to the number_of_videos (FIG. 9) of the ProgramInfo( ) of the Clip Information file corresponding to the generated transport stream file. In addition, the Clip Information file generating unit 32 sets “0x1B” to the stream_coding_type of the first video information of the ProgramInfo( ) and sets 0x20 to the stream_coding_type of the second video information.

In the Clip Information file generating unit 32, in addition to the file name, the version_number, and the number_of_videos and the stream_coding_type of the ProgramInfo( ), various information regarding the MPEG-4 MVC video stream is set to the Clip Information file. The Clip Information file that is generated by setting the various information is supplied to the ECC encoding unit 14.

In step S4, the PlayList file generating unit 31 sets “0110” to the version_number (FIG. 5) of the PlayList file.

In step S5, the PlayList file generating unit 31 sets the five digits included in the file name of the Clip Information file to the Clip_Information_file_name (FIG. 7) of the PlayItem( ).

In the PlayList file generating unit 31, in addition to the version_number and the Clip_Information_file_name of the PlayItem( ), various information regarding the MPEG-4 MVC video stream is set to the PlayList file. The PlayList file that is generated by setting the various information is supplied to the ECC encoding unit 14.

The PlayList file and the Clip Information file that are supplied to the ECC encoding unit 14 are subjected to the error correction coding together with the transport stream file including the MPEG-4 MVC video stream and are supplied to the recording control unit 15.

In step S6, the recording control unit 15 records the PlayList file, the Clip Information file, and the transport stream file on the optical disk 3 and ends the processing.

### [Specific Examples of Playlist File for MPEG-4 MVC Video and Clip Information File]

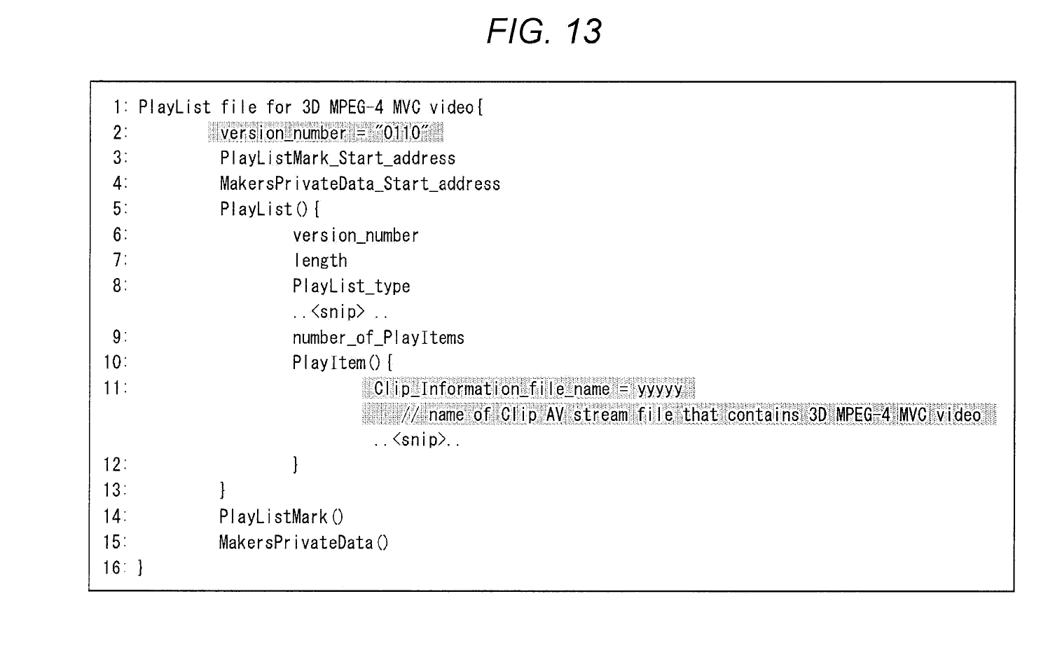

FIG. 13 is a diagram illustrating a specific example of the PlayList file for the MPEG-4 MVC video that is generated by the processing of FIG. 12.

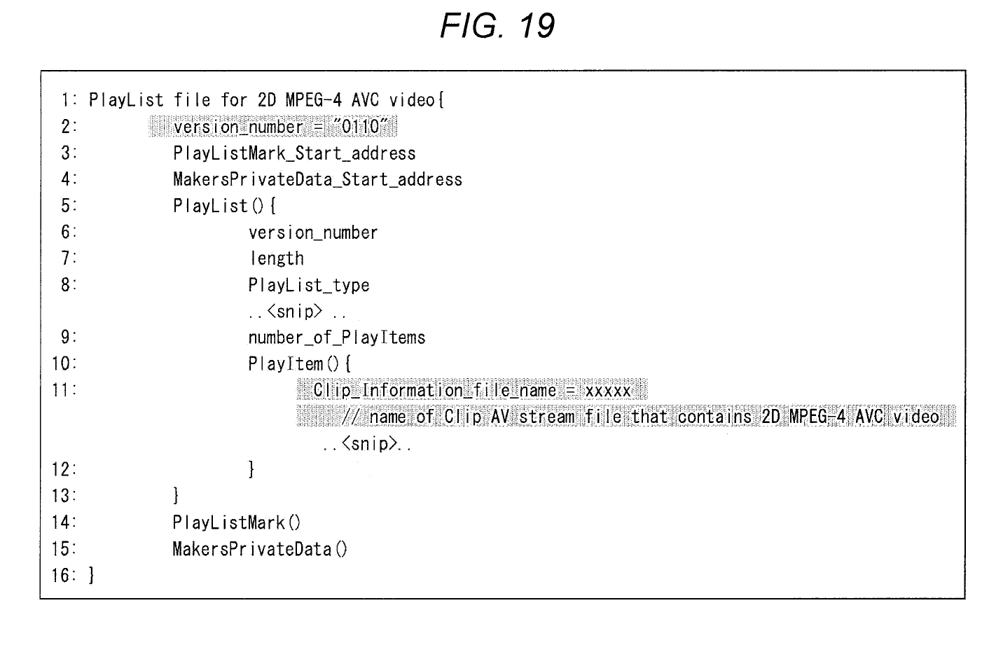

As illustrated in a second row, a value of “0110” is set to a version_number of the PlayList file for the MPEG-4 MVC video (step S4 of FIG. 12). “0110” that is set to the version_number is a value that is equal to a value (FIG. 19) of the version_number of the PlayList file for the MPEG-4 AVC video.

As illustrated in an eleventh row, “yyyyy” that shows the body portion of the file name of the Clip Information file corresponding to the transport stream file including the MPEG-4 MVC video stream is set to a PlayItem( ) of a PlayList( ) (step S5 of FIG. 12).

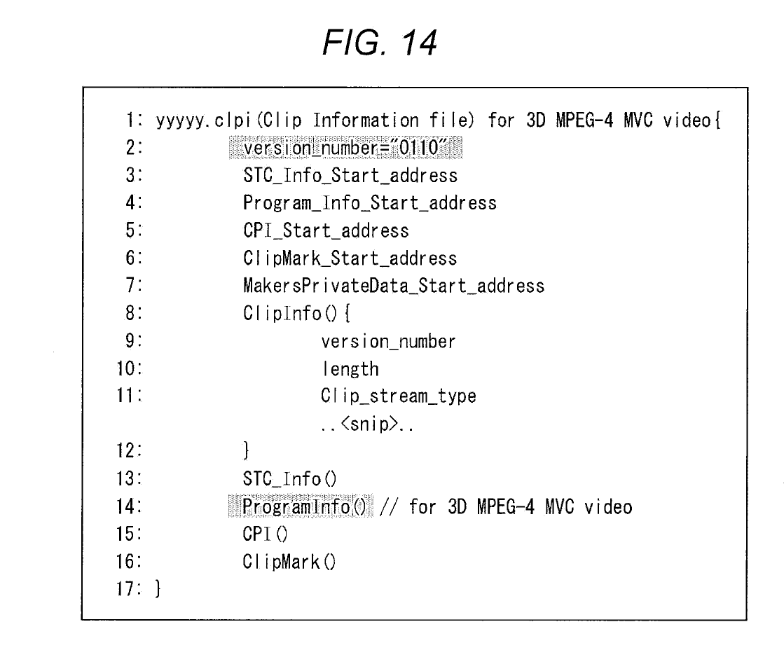

FIG. 14 is a diagram illustrating a specific example of the Clip Information file that is generated by the processing of FIG. 12.

As illustrated in a first row, a file name of the Clip Information file is “yyyyy.clpi”. A file name of the transport stream file that includes the MPEG-4 MVC video stream becomes “yyyyy.m2ts”.

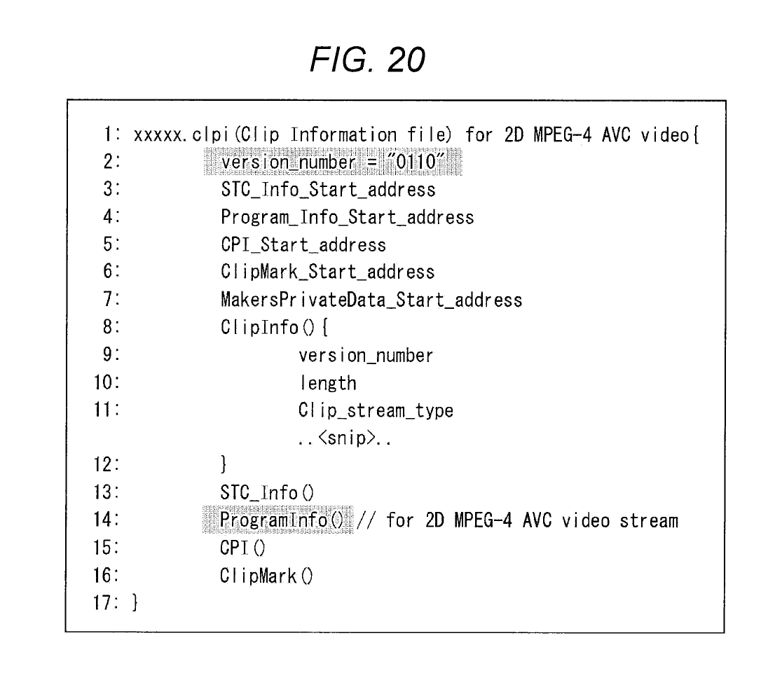

As illustrated in a second row, a value of “0110” is set to the version_number of the Clip Information file (step S2 of FIG. 12). “0110” that is set to the version_number is a value that is equal to a value (FIG. 20) of the version_number of the Clip Information file corresponding to the transport stream file including the MPEG-4 AVC video stream.

In ProgramInfo( ) of a fourteenth row, information regarding both the video streams of the Base view video stream and the Dependent view video stream included in the MPEG-4 MVC video stream is included.

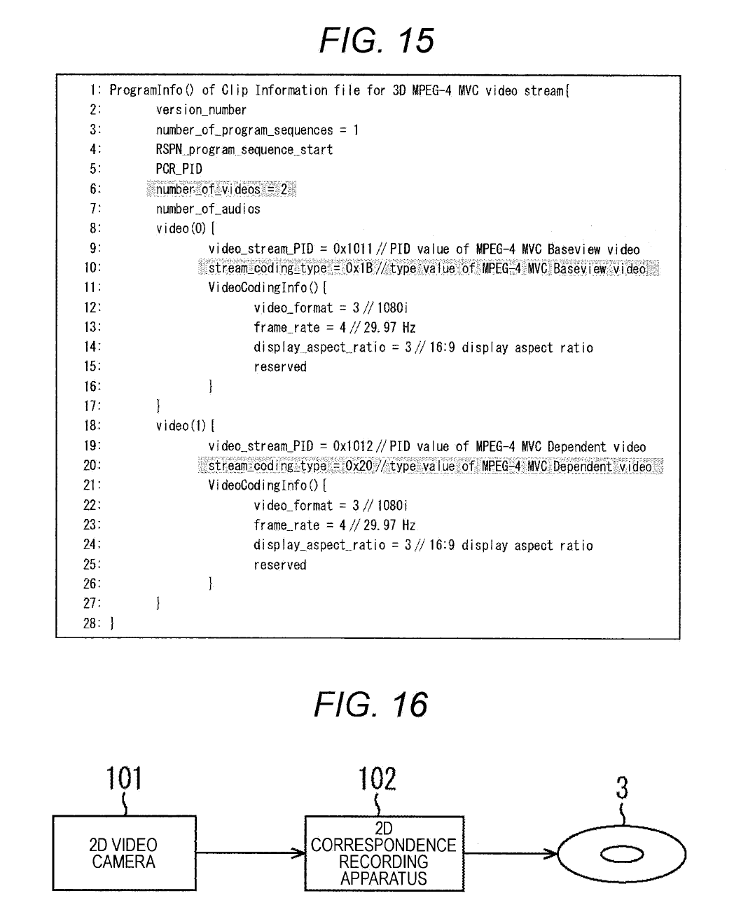

FIG. 15 is a diagram illustrating a specific example of the ProgramInfo( ) of the Clip Information file of FIG. 14.

As illustrated in a sixth row, a value of 2 is set to the number_of_videos. That is, video information appears twice in the ProgramInfo( ) (video(0) and video(1)).

Video(0) of eighth to seventeenth rows becomes the first video information. As illustrated in a ninth row, 0x1011 is set to a video_stream_PID of the video(0). 0x1011 shows a PID of a transport packet to store the Base view video stream.

As illustrated in a tenth row, 0x1B is set to a stream_coding_type of the video(0) (step S3 of FIG. 12). As described with reference to FIG. 10, 0x1B shows that the video stream referred to by the video_stream_PID is the MPEG-4 AVC video stream or the MPEG-4 MVC Base view video stream.

As illustrated in eleventh to fourteenth rows, a video_format showing that a video format is 1080i, a frame_rate showing that a frame rate is 29.97 Hz, and a display_aspect_ratio showing that an aspect ratio is 16:9 are included in VideoCodingInfo( ) of the video(0).

video(1) of eighteenth to twenty-seventh rows becomes the second video information. As illustrated in a nineteenth row, 0x1012 is set to a video_stream_PID of the video(1). 0x1012 shows a PID of a transport packet to store the Dependent view video stream.

As illustrated in a twentieth row, 0x20 is set to a stream_coding_type of the video(1) (step S3 of FIG. 12). As described with reference to FIG. 10, 0x20 shows that the video stream referred to by the video_stream_PID is the MPEG-4 MVC Dependent view video stream.

As illustrated in twenty-first to twenty-fourth rows, a video_format showing that a video format is 1080i, a frame_rate showing that a frame rate is 29.97 Hz, and a display_aspect_ratio showing that an aspect ratio is 16:9 are included in VideoCodingInfo( ) of the video(1).

### <1-2. With Respect to 2D Correspondence Recording Apparatus>

FIG. 16 is a diagram illustrating a configuration example of another recording system.

The recording system of FIG. 16 includes a 2D video camera 101 and a 2D correspondence recording apparatus 102. An optical disk 3 is inserted into a drive of the 2D correspondence recording apparatus 102.

Different from the 3D video camera 1 of FIG. 1, the 2D video camera 101 is a 2D correspondence video camera that cannot image a stereoscopic moving image. On a front surface of the 2D video camera 101, one lens is provided.

An imaged 2D moving image is recorded on a recording medium in the 2D video camera 101. Data of the 2D image that is recorded on the recording medium is transmitted to the 2D correspondence recording apparatus 102, when the 2D video camera 101 is connected to the 2D correspondence recording apparatus 102 through a USB cable.

The 2D correspondence recording apparatus 102 is a 2D correspondence recording apparatus that can record the 2D image supplied from the 2D video camera 101 on the optical disk 3. The 2D correspondence recording apparatus 102 does not have a function of recording the stereoscopic image imaged by the 3D correspondence video camera 1 of FIG. 1 on the optical disk 3.

The 2D correspondence recording apparatus 102 encodes the 2D image supplied from the 2D video camera 101 with the MPEG-4 AVC. The 2D correspondence recording apparatus 102 records an MPEG-4 AVC video stream obtained by the encoding on the optical disk 3 together with a PlayList file and a Clip Information file. The PlayList file that is generated by the 2D correspondence recording apparatus 102 is a PlayList file for MPEG-4 AVC video. In the PlayList file, each information of FIGS. 5 to 7 is included. The Clip Information file that is generated by the 2D correspondence recording apparatus 102 is a Clip Information file that corresponds to a transport stream file including the MPEG-4 AVC video stream. In the Clip Information file, each information of FIGS. 8 and 9 is included.

The optical disk 3 on which the MPEG-4 AVC video stream or the like is recorded is provided to a reproducing apparatus.

### [Configuration of 2D Correspondence Recording Apparatus]

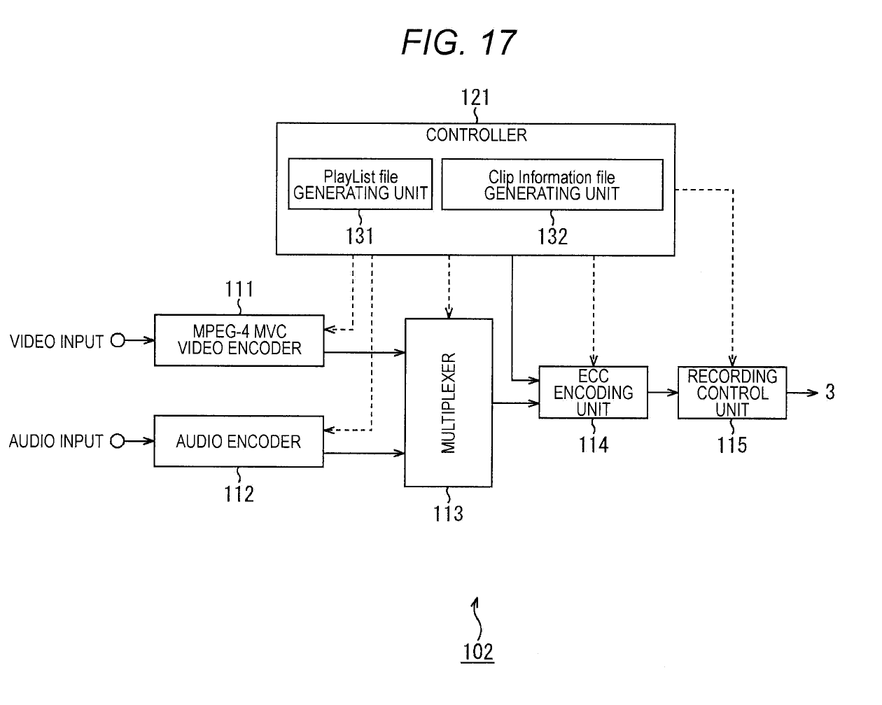

FIG. 17 is a block diagram illustrating a configuration example of the 2D correspondence recording apparatus 102.

The 2D correspondence recording apparatus 102 includes an MPEG-4 AVC video encoder 111, an audio encoder 112, a multiplexer 113, an ECC encoding unit 114, a recording control unit 115, and a controller 121. The 2D image input from the 2D video camera 101 is supplied to the MPEG-4 AVC video encoder 111 and the audio data is supplied to the audio encoder 112.

The MPEG-4 AVC video encoder 111 encodes the 2D image imaged by the 2D video camera 101 with the MPEG-4 AVC and generates the MPEG-4 AVC video stream. The MPEG-4 AVC video encoder 111 outputs the generated MPEG-4 AVC video stream to the multiplexer 113.

The audio encoder 112 encodes the audio data supplied from the 2D video camera 101 using a predetermined encoding method and outputs an audio stream obtained by the encoding to the multiplexer 113.

The multiplexer 113 multiplexes the MPEG-4 AVC video stream supplied from the MPEG-4 AVC video encoder 111 and the audio stream supplied from the audio encoder 112. The multiplexer 113 outputs a transport stream file to be a file of an AV stream obtained by the multiplexing to the ECC encoding unit 114.

The ECC encoding unit 114 performs error correction coding with respect to the transport stream file supplied from the multiplexer 113 and outputs the transport stream file after the error correction coding to the recording control unit 115. In addition, the ECC encoding unit 114 performs the error correction coding with respect to the PlayList file for the MPEG-4 AVC video and the Clip Information file supplied from the controller 121 and outputs the PlayList file and the Clip Information file after the error correction coding to the recording control unit 115.

The recording control unit 115 records the transport stream file, the PlayList file for the MPEG-4 AVC video, and the Clip Information file supplied from the ECC encoding unit 114 on the optical disk 3.

The controller 121 includes a CPU, a ROM, and a RAM and controls an entire operation of the 2D correspondence recording apparatus 102 according to a predetermined program. The program is executed, so that a PlayList file generating unit 131 and a Clip Information file generating unit 132 are realized in the controller 121.

The PlayList file generating unit 131 refers to the MPEG-4 AVC video stream generated by the MPEG-4 AVC video encoder 111 and generates the PlayList file for the MPEG-4 AVC video. The PlayList file generating unit 131 outputs the generated PlayList file for the MPEG-4 AVC video to the ECC encoding unit 114.

The Clip Information file generating unit 132 refers to the MPEG-4 AVC video stream generated by the MPEG-4 AVC video encoder 111 and generates the Clip Information file corresponding to the transport stream file including the MPEG-4 AVC video stream. The Clip Information file generating unit 132 outputs the generated Clip Information file to the ECC encoding unit 114.

The 2D image may be encoded with the MPEG-4 AVC in the 2D video camera 101 and the MPEG-4 AVC video stream may be input from the 2D video camera 101. In this case, the MPEG-4 AVC video stream that is input from the 2D video camera 101 is supplied to the multiplexer 113 as it is. The MPEG-4 AVC video stream that is supplied to the multiplexer 113 is processed in each unit, similar to the MPEG-4 AVC video stream generated by the MPEG-4 AVC video encoder 111, and is recorded on the optical disk 3.

### [Operation of 2D Correspondence Recording Apparatus]

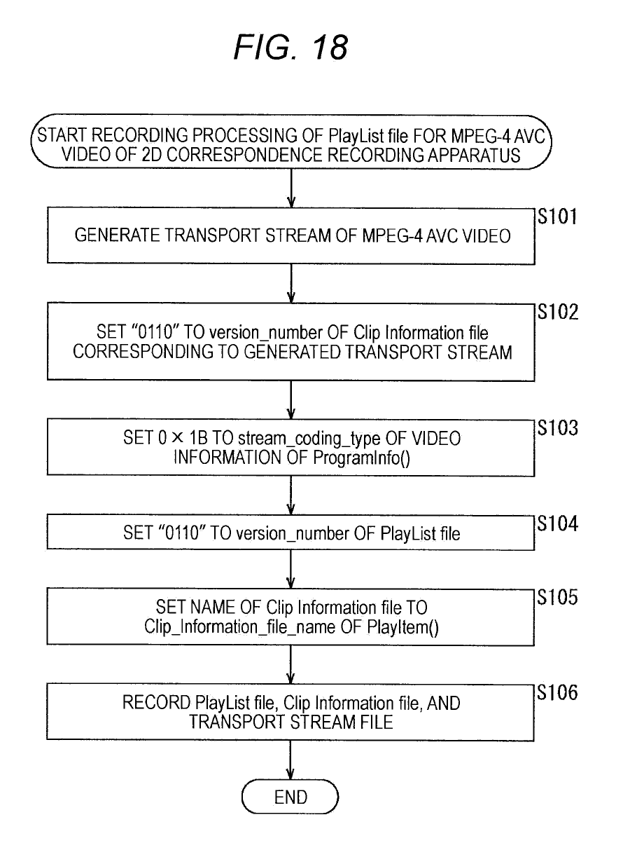

Here, processing of the 2D correspondence recording apparatus 102 that records the PlayList file for the MPEG-4 AVC video will be described with reference to a flowchart of FIG. 18. The processing of FIG. 18 starts when the 2D image is input from the 2D video camera 101.

In step S101, the MPEG-4 AVC video encoder 111 encodes the 2D image input from the 2D video camera 101 with the MPEG-4 AVC and generates the MPEG-4 AVC video stream. By performing multiplexing with the audio stream, the transport stream file including the MPEG-4 AVC video stream is generated.

In step S102, the Clip Information file generating unit 132 sets the file name of the Clip Information file corresponding to the generated transport stream file and sets “0110” to the version_number (FIG. 8).

In step S103, the Clip Information file generating unit 132 sets the value of 1 to the number_of_videos (FIG. 9) of the ProgramInfo( ) of the Clip Information file corresponding to the generated transport stream file. In addition, the Clip Information file generating unit 132 sets “0x1B” to the stream_coding_type of the video information of the ProgramInfo( ).

In the Clip Information file generating unit 132, in addition to the file name, the version_number, and the number_of_videos and the stream_coding_type of the ProgramInfo( ), various information regarding the MPEG-4 AVC video stream is set to the Clip Information file. The Clip Information file that is generated by setting the various information is supplied to the ECC encoding unit 114.

In step S104, the PlayList file generating unit 131 sets “0110” to the version_number (FIG. 5) of the PlayList file.

In step S105, the PlayList file generating unit 131 sets the five digits included in the file name of the Clip Information file to the Clip_Information_file_name (FIG. 7) of the PlayItem( ).

In the PlayList file generating unit 131, in addition to the version_number and the Clip_Information_file_name of the PlayItem( ), various information regarding the MPEG-4 AVC video stream is set to the PlayList file. The PlayList file that is generated by setting the various information is supplied to the ECC encoding unit 114.

The PlayList file and the Clip Information file that are supplied to the ECC encoding unit 114 are subjected to the error correction coding together with the transport stream file including the MPEG-4 AVC video stream and are supplied to the recording control unit 115.

In step S106, the recording control unit 115 records the PlayList file, the Clip Information file, and the transport stream file on the optical disk 3 and ends the processing.

### [Specific Examples of Playlist File for MPEG-4 AVC Video and Clip Information File]

FIG. 19 is a diagram illustrating a specific example of the PlayList file for the MPEG-4 AVC video that is generated by the processing of FIG. 18.

As illustrated in a second row, a value of “0110” is set to a version_number of the PlayList file for the MPEG-4 AVC video (step S104 of FIG. 18). “0110” that is set to the version_number is a value that is equal to a value (FIG. 13) of the version_number of the PlayList file for the MPEG-4 MVC video.

As illustrated in an eleventh row, “xxxxx” that shows the body portion of the file name of the Clip Information file corresponding to the transport stream file including the MPEG-4 AVC video stream is set to a PlayItem( ) of a PlayList( ) (step S105 of FIG. 18).

FIG. 20 is a diagram illustrating a specific example of the Clip Information file that is generated by the processing of FIG. 18.

As illustrated in a first row, a file name of the Clip Information file is “xxxxx.clpi”. A file name of the transport stream file that includes the MPEG-4 AVC video stream becomes “xxxxx.m2ts”.

As illustrated in a second row, a value of “0110” is set to the version_number of the Clip Information file (step S102 of FIG. 18). “0110” that is set to the version_number is a value that is equal to a value (FIG. 14) of the version_number of the Clip Information file corresponding to the transport stream file including the MPEG-4 MVC video stream.

In ProgramInfo( ) of a fourteenth row, information regarding the MPEG-4 AVC video stream is included.

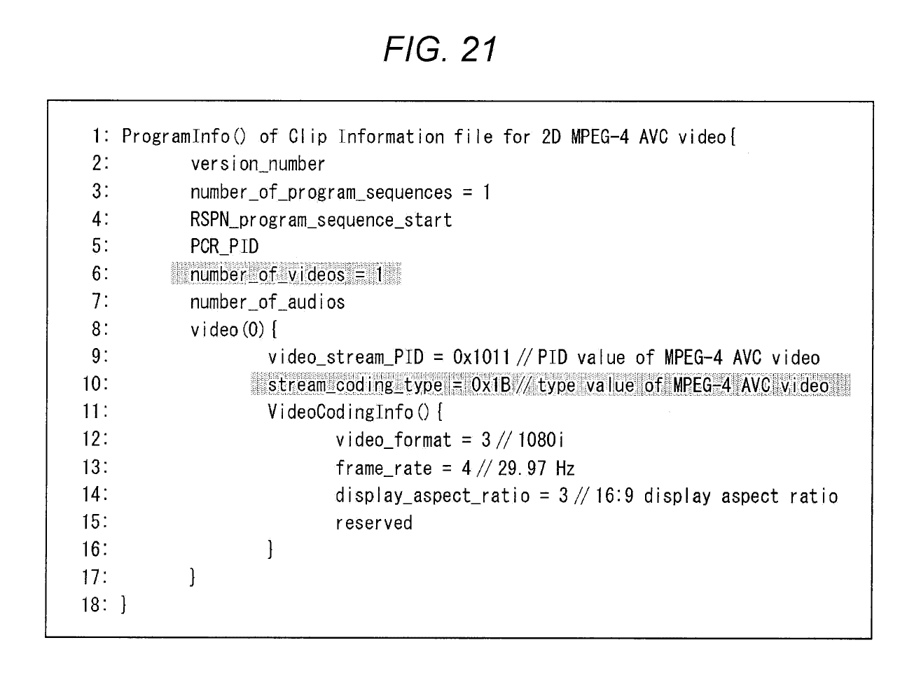

FIG. 21 is a diagram illustrating a specific example of the ProgramInfo( ) of the Clip Information file of FIG. 20.

As illustrated in a sixth row, a value of 1 is set to the number_of_videos. That is, video information appears once in the ProgramInfo( ) (video(0)).

Video(0) of eighth to seventeenth rows becomes video information. As illustrated in a ninth row, 0x1011 is set to a video_stream_PID of the video(0). 0x1011 shows a PID of a transport packet to store the MPEG-4 AVC video stream.

As illustrated in a tenth row, 0x1B is set to a stream_coding_type of the video(0) (step S103 of FIG. 18). As described with reference to FIG. 10, 0x1B shows that the video stream referred to by the video_stream_PID is the MPEG-4 AVC video stream or the MPEG-4 MVC Base view video stream.

As illustrated in eleventh to fourteenth rows, a video_format showing that a video format is 1080i, a frame_rate showing that a frame rate is 29.97 Hz, and a display_aspect_ratio showing that an aspect ratio is 16:9 are included in VideoCodingInfo( ) of the video(0).

### 2. Example of Reproduction Side

Next, a configuration and an operation of an apparatus of a reproduction side that reproduces the optical disk 3 provided from the 3D correspondence recording apparatus 2 and the optical disk 3 provided from the 2D correspondence recording apparatus 102 will be described.

On the optical disk 3 that is provided from the 3D correspondence recording apparatus 2, the transport stream file including the MPEG-4 MVC video stream, the PlayList file for the MPEG-4 MVC video, and the Clip Information file are recorded. Meanwhile, on the optical disk 3 that is provided from the 2D correspondence recording apparatus 102, the transport stream file including the MPEG-4 AVC video stream, the PlayList file for the MPEG-4 AVC video, and the Clip Information file are recorded.

### <2-1. With Respect to 3D Correspondence Reproducing Apparatus>

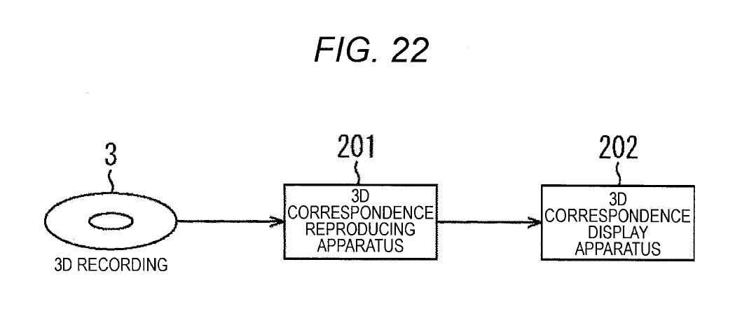

FIG. 22 is a diagram illustrating a configuration example of a reproduction system.

The reproduction system of FIG. 22 includes a 3D correspondence reproducing apparatus 201 and a 3D correspondence display apparatus 202. An optical disk 3 that is provided from the 3D correspondence recording apparatus 2 is inserted into a drive of the 3D correspondence reproducing apparatus 201.

The 3D correspondence reproducing apparatus 201 is a 3D correspondence reproducing apparatus that can reproduce an MPEG-4 MVC video stream. The 3D correspondence reproducing apparatus 201 reproduces the MPEG-4 MVC video stream according to a PlayList file for MPEG-4 MVC video recorded on the optical disk 3.

The 3D correspondence reproducing apparatus 201 outputs an L image obtained by decoding a Base view video stream and an R image obtained by decoding a Dependent view video stream to the 3D correspondence display apparatus 202 with a frame sequential format. The 3D correspondence reproducing apparatus 201 and the 3D correspondence display apparatus 202 are connected through, for example, an HDMI (High Definition Multimedia Interface) cable.

The 3D correspondence display apparatus 202 is a 3D correspondence TV that can display a stereoscopic image having the frame sequential format. In the 3D correspondence display apparatus 202, a display device composed of an LCD (Liquid Crystal Display) is provided. The 3D correspondence display apparatus 202 receives the L and R images supplied from the 3D correspondence reproducing apparatus 201 and alternately displays the L and R images. Of course, the 3D correspondence display apparatus 202 has a function of displaying a 2D image.

### [Configuration of 3D Correspondence Reproducing Apparatus]

FIG. 23 is a block diagram illustrating a configuration example of the 3D correspondence reproducing apparatus 201.

The 3D correspondence reproducing apparatus 201 includes a reading unit 211, an ECC decoding unit 212, a demultiplexer 213, an MPEG-4 MVC video decoder 214, an audio decoder 215, and a controller 221.

The reading unit 211 reads a transport stream file, a PlayList file, and a Clip Information file from the optical disk 3 and outputs the transport stream file, the PlayList file, and the Clip Information file to the ECC decoding unit 212. In the transport stream file that is read from the optical disk 3 provided from the 3D correspondence recording apparatus 2, the MPEG-4 MVC video stream is included. The PlayList file that is read from the optical disk 3 provided from the 3D correspondence recording apparatus 2 is a PlayList file for the MPEG-4 MVC video.

The ECC decoding unit 212 performs error correction decoding with respect to the transport stream file supplied from the reading unit 211 and outputs the transport stream file after the error correction decoding to the demultiplexer 213. In addition, the ECC decoding unit 212 performs the error correction decoding with respect to the PlayList file and the Clip Information file supplied from the reading unit 211 and outputs the PlayList file and the Clip Information file after the error correction decoding to the controller 221.

The demultiplexer 213 extracts the MPEG-4 MVC video stream and the audio stream from the transport stream file supplied from the ECC decoding unit 212. The demultiplexer 213 outputs the MPEG-4 MVC video stream to the MPEG-4 MVC video decoder 214 and outputs the audio stream to the audio decoder 215.

The MPEG-4 MVC video decoder 214 decodes the Base view video stream included in the MPEG-4 MVC video stream supplied from the demultiplexer 213 with the MPEG-4 AVC and outputs the L image. In addition, the MPEG-4 MVC video decoder 214 decodes the Dependent view video stream included in the MPEG-4 MVC video stream using the L image obtained by decoding the Base view video stream as a reference image and outputs the R image. The L and R images are alternately output from the MPEG-4 MVC video decoder 214 to the 3D correspondence display apparatus 202.

The audio decoder 215 decodes the audio stream supplied from the demultiplexer 213 and outputs the audio data to the 3D correspondence display apparatus 202. In the 3D correspondence display apparatus 202, a sound is output on the basis of the audio data supplied from the audio decoder 215.

The controller 221 includes a CPU, a ROM, and a RAM and controls an entire operation of the 3D correspondence reproducing apparatus 201 according to a predetermined program. The program is executed, so that a PlayList file analyzing unit 231 and a Clip Information file analyzing unit 232 are realized in the controller 221.

The PlayList file analyzing unit 231 analyzes the PlayList file supplied from the ECC decoding unit 212 and controls each unit.

For example, the PlayList file analyzing unit 231 specifies a file name of the Clip Information file set as a read target, from a Clip_Information_file_name of a PlayItem( ) of the PlayList file. In addition, the PlayList file analyzing unit 231 specifies the transport stream file set as a read target, from the file name of the Clip Information file. The file is read by the reading unit 211 on the basis of the file name specified by the PlayList file analyzing unit 231.

The Clip Information file analyzing unit 232 analyzes the Clip Information file supplied from the ECC decoding unit 212 and controls each unit.

For example, the Clip Information file analyzing unit 232 specifies a PID of a transport packet to store a video stream set as an extraction target, from a video_stream_PID included in video information of ProgramInfo( ) of the Clip Information file. In addition, the Clip Information file analyzing unit 232 specifies a PID of a transport packet to store an audio stream set as an extraction target, from an audio_stream_PID included in audio information of the ProgramInfo( ) of the Clip Information file. The transport packet is extracted by the demultiplexer 213 on the basis of the PID specified by the Clip Information file analyzing unit 232.

### [Operation of 3D Correspondence Reproducing Apparatus]

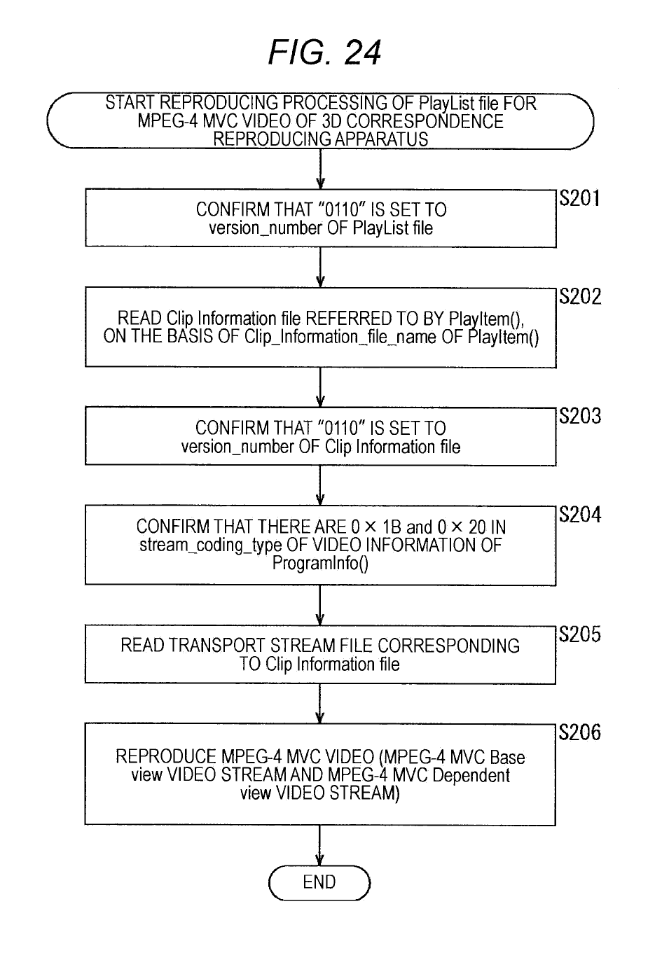

Here, processing of the 3D correspondence reproducing apparatus 201 that reproduces the PlayList file for the MPEG-4 MVC video will be described with reference to a flowchart of FIG. 24.

The processing of FIG. 24 starts when the optical disk 3 is inserted into the drive of the 3D correspondence reproducing apparatus 201 and reproduction is instructed. When the reproduction is instructed, the PlayList file is read from the optical disk 3, is subjected to the error correction decoding by the ECC decoding unit 212, and is supplied to the PlayList file analyzing unit 231.

In step S201, the playlist file analyzing unit 231 confirms that “0110” is set to a version_number of the PlayList file.

Thereby, the PlayList file analyzing unit 231 can specify the PlayList file read from the optical disk 3 being the PlayList file for the MPEG-4 MVC video including each information of FIG. 13 or the PlayList file for the MPEG-4 AVC video including each information of FIG. 19.

In step S202, the PlayList file analyzing unit 231 specifies a file name of a Clip Information file of a Clip referred to by a PlayItem( ), on the basis of a Clip_Information_file_name of the PlayItem( ), controls the reading unit 211, and performs a read operation. The Clip Information file that is read from the optical disk 3 is subjected to the error correction decoding by the ECC decoding unit 212 and is supplied to the Clip Information file analyzing unit 232.

In step S203, the Clip Information file analyzing unit 232 confirms that “0110” is set to a version_number of the Clip Information file.

Thereby, the Clip Information file analyzing unit 232 can specify the Clip Information file read from the optical disk 3 being the Clip Information file including each information of FIG. 14 or 20.

In step S204, the Clip Information file analyzing unit 232 specifies two video information being included in ProgramInfo( ), on the basis of a value of 2 being setting to the number_of_videos of the ProgramInfo( ) of the Clip Information file. In addition, the Clip Information file analyzing unit 232 confirms that 0x1B is set to a stream_coding_type of the first video information and 0x20 is set to a stream_coding_type of the second video information.

Thereby, the Clip Information file analyzing unit 232 can specify a video stream of a reproduction target being the MPEG-4 MVC video stream.

In step S205, the Clip Information file analyzing unit 232 controls the reading unit 211 and reads the transport stream file including the MPEG-4 MVC video stream corresponding to the Clip Information file from the optical disk 3. A file name of the transport stream file that becomes a read target is specified from the file name of the Clip Information file read in step S202.

The Clip Information file analyzing unit 232 specifies a PID of a transport packet to store the Bas view video stream, from a video_stream_PID of the first video information of the Clip Information file. In addition, the Clip Information file analyzing unit 232 specifies a PID of a transport packet to store the Dependent view video stream, from a video_stream_PID of the second video information.

The Clip Information file analyzing unit 232 outputs the specified PID to the demultiplexer 213 and extracts the Base view video stream and the Dependent view video stream by the demultiplexer 213. The Base view video stream and the Dependent view video stream that are extracted by the demultiplexer 213 are supplied to the MPEG-4 MVC video decoder 214.

In step S206, the Clip Information file analyzing unit 232 controls the MPEG-4 MVC video decoder 214, reproduces the Base view video stream and the Dependent view video stream, and ends the processing. The L image that is obtained by decoding the Base view video stream and the R image that is obtained by decoding the Dependent view video stream are supplied to the 3D correspondence display apparatus 202 and are displayed by the 3D correspondence display apparatus 202.

Thereby, the 3D correspondence reproducing apparatus 201 can reproduce the MPEG-4 MVC video stream according to the PlayList file for the MPEG-4 MVC video and can display the stereoscopic image.

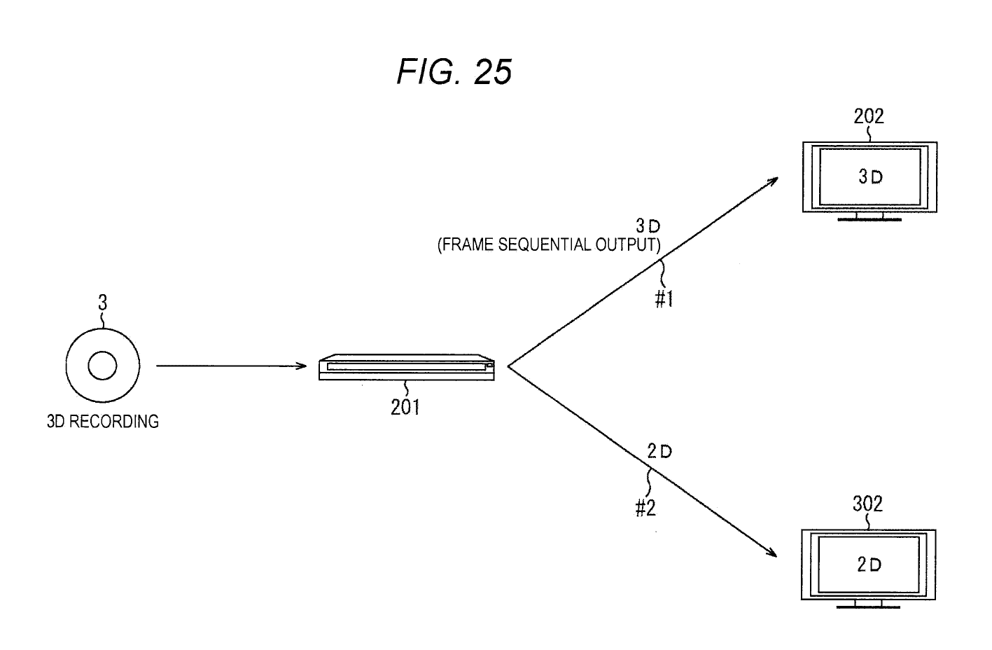

FIG. 25 is a diagram illustrating switching of an output of the 3D correspondence reproducing apparatus 201.

When a cable connecting the 3D correspondence reproducing apparatus 201 and a display apparatus is the HDMI cable, the 3D correspondence reproducing apparatus 201 can acquire information regarding the display capability from the display apparatus. The 3D correspondence reproducing apparatus 201 switches a video stream set as a reproduction target, according to the display capability of the display apparatus.

The case in which the display apparatus connected to the 3D correspondence reproducing apparatus 201 is the 3D correspondence display apparatus 202 that can display the stereoscopic image having the frame sequential format is considered.

In this case, the 3D correspondence reproducing apparatus 201 reproduces the MPEG-4 MVC video stream according to the PlayList file for the MPEG-4 MVC video, as described above. The 3D correspondence reproducing apparatus 201 outputs the L image obtained by decoding the Base view video stream and the R image obtained by decoding the Dependent view video stream to the 3D correspondence display apparatus 202 and displays the L and R images by the 3D correspondence display apparatus 202, as illustrated by an arrow #1.

Thereby, in the 3D correspondence display apparatus 202, a stereoscopic image that can be three-dimensionally viewed is displayed with the frame sequential format.

Meanwhile, the case in which the display apparatus connected to the 3D correspondence reproducing apparatus 201 is the 2D correspondence display apparatus 302 that cannot display the stereoscopic image is considered.

In this case, the 3D correspondence reproducing apparatus 201 reproduces only the Base view video stream of the Base view video stream and the Dependent view video stream included in the MPEG-4 MVC video stream, according to the PlayList file for the MPEG4-MVC video. Because the Base view video stream is a stream obtained by encoding the L image with the MPEG-4 AVC, single reproduction is enabled.

The reproduction of only the Base view video stream is performed using the first video information included in the ProgramInfo( ) of the Clip Information file. In this case, the second video information is not used. The 3D correspondence reproducing apparatus 201 outputs the L image obtained by decoding the Base view video stream to the 2D correspondence display apparatus 302 and displays the L image by the 2D correspondence display apparatus 302, as illustrated by an arrow #2.

Thereby, in the 2D correspondence display apparatus 302, a 2D image that cannot be three-dimensionally viewed is displayed.

As such, according to the PlayList file for the MPEG-4 MVC video, the output can be switched according to the display capability of the display apparatus.

### <2-2. With Respect to 2D Correspondence Reproducing Apparatus>

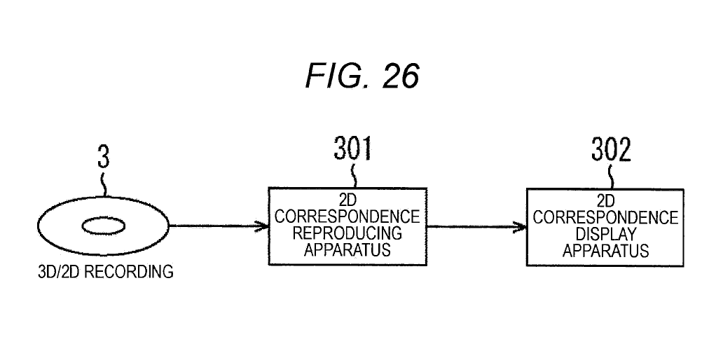

FIG. 26 is a diagram illustrating another configuration example of the reproducing system.

The reproduction system of FIG. 26 includes a 2D correspondence reproducing apparatus 301 and a 2D correspondence display apparatus 302. The optical disk 3 that is provided from the 2D correspondence recording apparatus 102 or the optical disk 3 that is provided from the 3D correspondence recording apparatus 2 is inserted into a drive of the 2D correspondence reproducing apparatus 301.

The 2D correspondence reproducing apparatus 301 is a 2D correspondence reproducing apparatus that can reproduce an MPEG-4 AVC video stream. The 2D correspondence reproducing apparatus 301 does not have a function of reproducing the MPEG-4 MVC video stream. The case in which the optical disk 3 on which the MPEG-4 MVC video stream is recorded as well as the optical disk 3 on which the MPEG-4 AVC video stream is recorded is reproduced by the 2D correspondence reproducing apparatus 301 to be a 3D non-correspondence reproducing apparatus will be described.

When the optical disk 3 provided from the 2D correspondence recording apparatus 102 is reproduced, the 2D correspondence reproducing apparatus 301 reproduces the MPEG-4 AVC video stream according to the PlayList file for the MPEG-4 AVC video recorded on the optical disk 3.

Meanwhile, when the optical disk 3 provided from the 3D correspondence recording apparatus 2 is reproduced, the 2D correspondence reproducing apparatus 301 reproduces only the Base view video stream included in the MPEG-4 MVC video stream, according to the PlayList file for the MPEG-4 MVC video recorded on the optical disk 3. The reproduction of only the Base view video stream by the 2D correspondence reproducing apparatus 301 is performed in the same manner as the case in which the 3D correspondence reproducing apparatus 201 reproduces only the Base view video stream, as described above with reference to FIG. 25.

The 2D correspondence reproducing apparatus 301 outputs the 2D image obtained by reproducing the MPEG-4 AVC video stream or the L image obtained by reproducing the Base view video stream to the 2D correspondence display apparatus 302. The 2D correspondence reproducing apparatus 301 and the 2D correspondence display apparatus 302 are connected through the HDMI cable.

The 2D correspondence display apparatus 302 is a 2D correspondence TV that cannot display a stereoscopic image. The 2D correspondence display apparatus 302 receives an image supplied from the 2D correspondence reproducing apparatus 301 and displays a 2D image.

### [Configuration of 2D Correspondence Reproducing Apparatus]

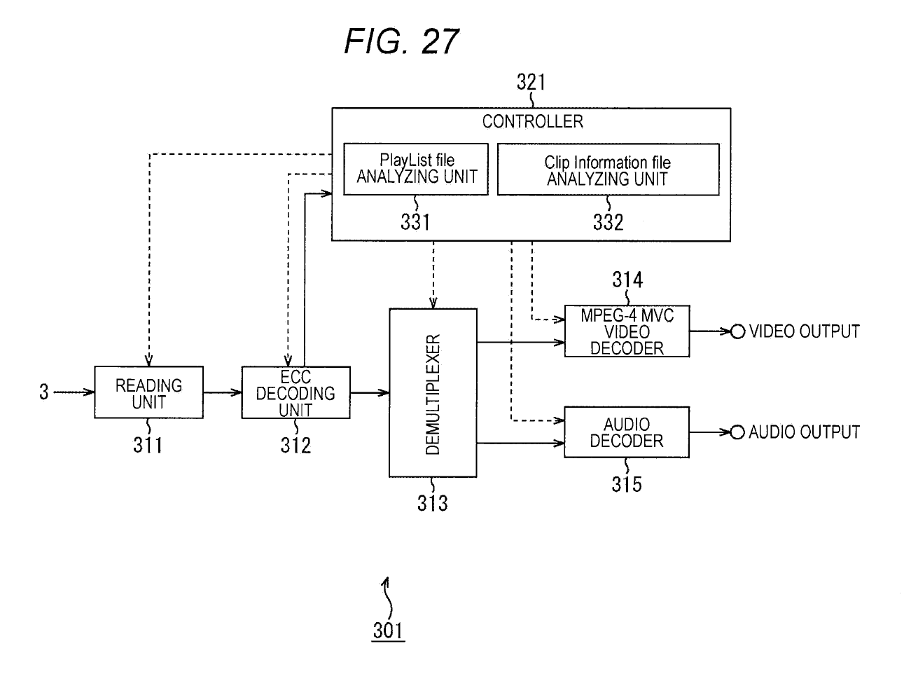

FIG. 27 is a block diagram illustrating a configuration example of the 2D correspondence reproducing apparatus 301.

The 2D correspondence reproducing apparatus 301 includes a reading unit 311, an ECC decoding unit 312, a demultiplexer 313, an MPEG-4 AVC video decoder 314, an audio decoder 315, and a controller 321.

The reading unit 311 reads a transport stream file, a PlayList file, and a Clip Information file from the optical disk 3 and outputs the transport stream file, the PlayList file, and the Clip Information file to the ECC decoding unit 312.

When the optical disk 3 provided from the 2D correspondence recording apparatus 102 is reproduced, the MPEG-4 AVC video stream is included in the transport stream file read from the optical disk 3. In this case, the PlayList file that is read from the optical disk 3 is a PlayList file for the MPEG-4 AVC video.

Meanwhile, when the optical disk 3 provided from the 3D correspondence recording apparatus 2 is reproduced, the MPEG-4 MVC video stream is included in the transport stream file read from the optical disk 3. In this case, the PlayList file that is read from the optical disk 3 is a PlayList file for the MPEG-4 MVC video.

The ECC decoding unit 312 performs error correction decoding with respect to the transport stream file supplied from the reading unit 311 and outputs the transport stream file after the error correction decoding to the demultiplexer 313. In addition, the ECC decoding unit 312 performs the error correction decoding with respect to the PlayList file and the Clip Information file supplied from the reading unit 311 and outputs the PlayList file and the Clip Information file after the error correction decoding to the controller 321.

When the optical disk 3 provided from the 2D correspondence recording apparatus 102 is reproduced, the demultiplexer 313 extracts the MPEG-4 AVC video stream and the audio stream, from the transport stream file supplied from the ECC decoding unit 312. The demultiplexer 313 outputs the MPEG-4 AVC video stream to the MPEG-4 AVC video decoder 314 and outputs the audio stream to the audio decoder 315.

In addition, when the optical disk 3 provided from the 3D correspondence recording apparatus 2 is reproduced, the demultiplexer 313 extracts the Base view video stream included in the MPEG-4 MVC video stream and the audio stream, from the transport stream file supplied from the ECC decoding unit 312. The demultiplexer 313 outputs the Base view video stream to the MPEG-4 AVC video decoder 314 and outputs the audio stream to the audio decoder 315.

The Base view video stream is a video stream that is obtained by encoding the L image with the MPEG-4 AVC. In both the cases of the case in which the optical disk 3 provided from the 2D correspondence recording apparatus 102 is reproduced and the case in which the optical disk 3 provided from the 3D correspondence recording apparatus 2 is reproduced, the MPEG-4 AVC video stream is supplied to the MPEG-4 AVC video decoder 314.

The MPEG-4 AVC video decoder 314 decodes the MPEG-4 AVC video stream supplied from the demultiplexer 313 with the MPEG-4 AVC and outputs the 2D image.

The audio decoder 315 decodes the audio stream supplied from the demultiplexer 313 and outputs the audio data to the 2D correspondence display apparatus 302. In the 2D correspondence display apparatus 302, a sound is output on the basis of the audio data output from the audio decoder 315.

The controller 321 includes a CPU, a ROM, and a RAM and controls an entire operation of the 2D correspondence reproducing apparatus 301 according to a predetermined program. The program is executed, so that a PlayList file analyzing unit 331 and a Clip Information file analyzing unit 332 are realized in the controller 321.

The PlayList file analyzing unit 331 analyzes the PlayList file supplied from the ECC decoding unit 312 and controls each unit. The PlayList file analyzing unit 331 has the same function as the PlayList file analyzing unit 231 of FIG. 23.

The Clip Information file analyzing unit 332 analyzes the Clip Information file supplied from the ECC decoding unit 312 and controls each unit. The Clip Information file analyzing unit 332 has the same function as the Clip Information file analyzing unit 232 of FIG. 23.

### [Operation of 2D Correspondence Reproducing Apparatus]

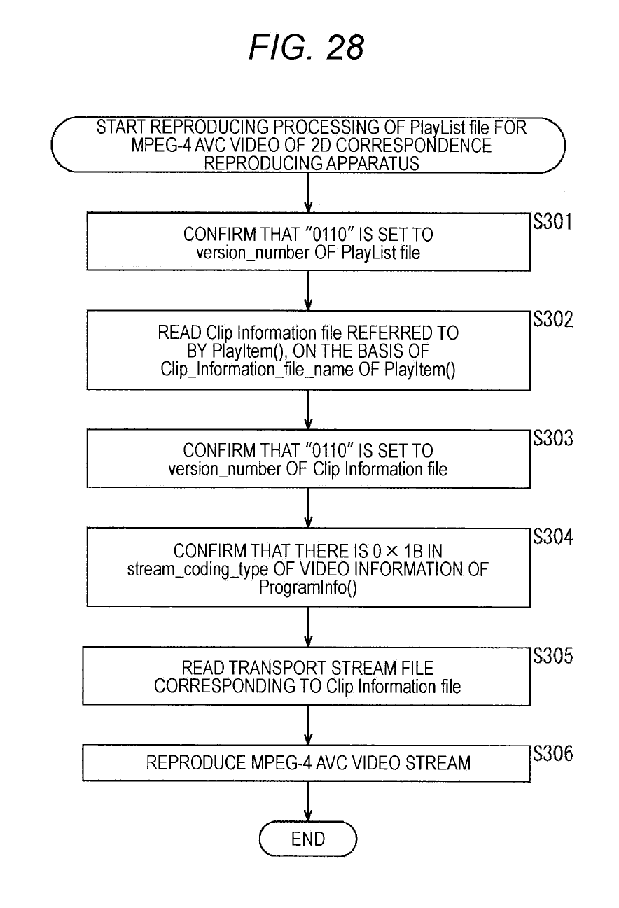

Here, processing of the 2D correspondence reproducing apparatus 301 that reproduces the PlayList file for the MPEG-4 AVC video will be described with reference to a flowchart of FIG. 28. The processing of FIG. 28 becomes processing for reproducing the optical disk 3 provided from the 2D correspondence recording apparatus 102.

The processing of FIG. 28 starts when the optical disk 3 is inserted into the drive of the 2D correspondence reproducing apparatus 301 and reproduction is instructed. When the reproduction is instructed, the PlayList file is read from the optical disk 3, is subjected to the error correction decoding by the ECC decoding unit 312, and is supplied to the PlayList file analyzing unit 331.

In step S301, the PlayList file analyzing unit 331 confirms that “0110” is set to a version_number of the PlayList file.

Thereby, the PlayList file analyzing unit 331 can specify the PlayList file read from the optical disk 3 being the PlayList file for the MPEG-4 MVC video including each information of FIG. 13 or the PlayList file for the MPEG-4 AVC video including each information of FIG. 19.

In step S302, the PlayList file analyzing unit 331 specifies a file name of a Clip Information file of a Clip referred to by a PlayItem( ), on the basis of a Clip_Information file_name of the PlayItem( ), controls the reading unit 311, and performs a read operation. The Clip Information file that is read from the optical disk 3 is subjected to the error correction decoding by the ECC decoding unit 312 and is supplied to the Clip Information file analyzing unit 332.

In step S303, the Clip Information file analyzing unit 332 confirms that “0110” is set to a version_number of the Clip Information file.

Thereby, the Clip Information file analyzing unit 332 can specify the Clip Information file read from the optical disk 3 being the Clip Information file including each information of FIG. 14 or 20.

In step S304, the Clip Information file analyzing unit 332 specifies one video information being included in ProgramInfo( ), on the basis of a value of 1 being setting to the number_of_videos of the ProgramInfo( ) of the Clip Information file. In addition, the Clip Information file analyzing unit 332 confirms that 0x1B is set to a stream_coding_type of the video information.

Thereby, the Clip Information file analyzing unit 332 can specify a video stream of a reproduction target being the MPEG-4 AVC video stream.

In step S305, the Clip Information file analyzing unit 332 controls the reading unit 311 and reads the transport stream file including the MPEG-4 AVC video stream corresponding to the Clip Information file from the optical disk 3. A file name of the transport stream file that becomes a read target is specified from the file name of the Clip Information file read in step S302.

The Clip Information file analyzing unit 332 specifies a PID of a transport packet to store the MPEG-4 AVC video stream, from a video_stream_PID of the video information of the Clip Information file. The Clip Information file analyzing unit 332 outputs the specified PID to the demultiplexer 313 and extracts the MPEG-4 AVC video stream by the demultiplexer 313. The MPEG-4 AVC video stream that is extracted by the demultiplexer 313 is supplied to the MPEG-4 AVC video decoder 314.

In step S306, the Clip Information file analyzing unit 332 controls the MPEG-4 AVC video decoder 314, reproduces the MPEG-4 AVC video stream, and ends the processing. The 2D image that is obtained by decoding the MPEG-4 AVC video stream is supplied to the 2D correspondence display apparatus 302 and is displayed by the 2D correspondence display apparatus 302.

Thereby, the 2D correspondence reproducing apparatus 301 can reproduce the MPEG-4 AVC video stream according to the PlayList file for the MPEG-4 AVC video and can display the 2D image.

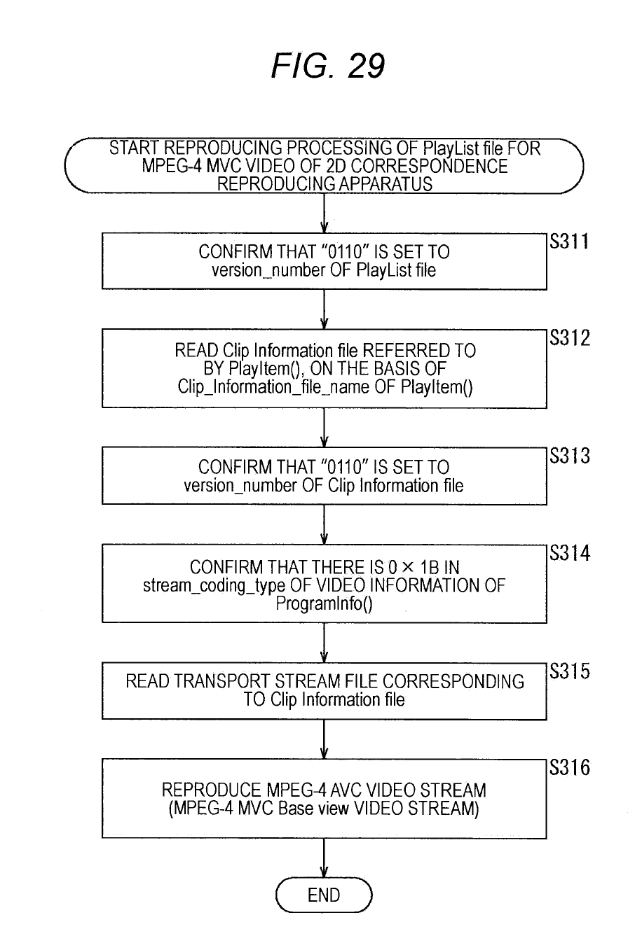

Next, processing of the 2D correspondence reproducing apparatus 301 that reproduces the PlayList file for the MPEG-4 MVC video will be described with reference to a flowchart of FIG. 29. The processing of FIG. 29 becomes processing for reproducing the optical disk 3 provided from the 3D correspondence recording apparatus 2.

The processing of FIG. 29 starts when the optical disk 3 is inserted into the drive of the 2D correspondence reproducing apparatus 301 and reproduction is instructed. When the reproduction is instructed, the PlayList file is read from the optical disk 3, is subjected to the error correction decoding by the ECC decoding unit 312, and is supplied to the PlayList file analyzing unit 331. Processing of steps S311 to S313 of FIG. 29 is the same processing as the processing of steps S301 to S303 of FIG. 28.

That is, in step S311, the PlayList file analyzing unit 331 confirms that “0110” is set to a version_number of the PlayList file.

In step S312, the PlayList file analyzing unit 331 specifies a file name of a Clip Information file of a Clip referred to by a PlayItem( ), on the basis of a Clip_Information_file_name of the PlayItem( ), controls the reading unit 311, and performs a read operation.

In step S313, the Clip Information file analyzing unit 332 confirms that “0110” is set to a version_number of the Clip Information file.

In step S314, the Clip Information file analyzing unit 332 specifies two video information being included in ProgramInfo( ), on the basis of a value of 2 being setting to the number_of_videos of the ProgramInfo( ) of the Clip Information file. In addition, the Clip Information file analyzing unit 332 confirms that 0x1B is set to a stream_coding_type of the first video information. The Clip Information file analyzing unit 332 ignores 0x20 set to a stream_coding_type of the second video information.

Thereby, the Clip Information file analyzing unit 332 can specify a video stream of a reproduction target being the Base view video stream included in the MPEG-4 MVC video stream, that is, the MPEG-4 AVC video stream.

In step S315, the Clip Information file analyzing unit 332 controls the reading unit 311 and reads the transport stream file including the MPEG-4 MVC video stream corresponding to the Clip Information file from the optical disk 3. A file name of the transport stream file that becomes a read target is specified from the file name of the Clip Information file read in step S312.

The Clip Information file analyzing unit 332 specifies a PID of a transport packet to store the Base view video stream, from a video_stream_PID of the first video information of the Clip Information file. The Clip Information file analyzing unit 332 outputs the specified PID to the demultiplexer 313 and extracts the Base view video stream by the demultiplexer 313. The Base view video stream that is extracted by the demultiplexer 313 is supplied to the MPEG-4 AVC video decoder 314.

In step S316, the Clip Information file analyzing unit 332 controls the MPEG-4 AVC video decoder 314, reproduces the Base view video stream to be the MPEG-4 AVC video stream, and ends the processing. The 2D image that is obtained by decoding the Base view video stream is supplied to the 2D correspondence display apparatus 302 and is displayed by the 2D correspondence display apparatus 302.

Thereby, the 2D correspondence reproducing apparatus 301 can reproduce the Base view video stream included in the MPEG-4 AVC video stream, according to the PlayList file for the MPEG-4 MVC video, and can display the 2D image.

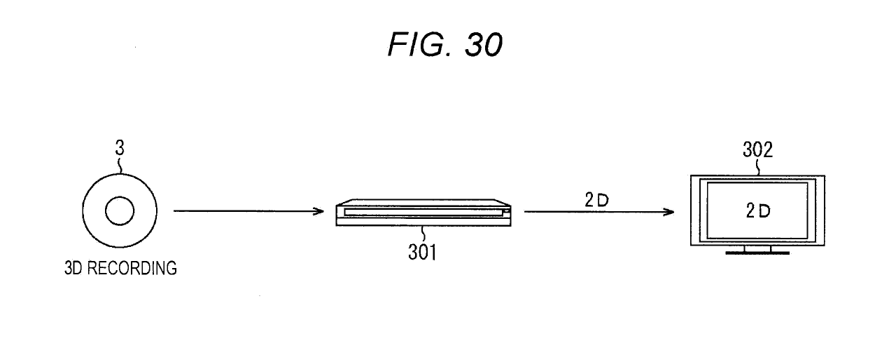

FIG. 30 is a diagram illustrating an output of the 2D correspondence reproducing apparatus 301.

When the optical disk 3 provided from the 3D correspondence recording apparatus 2 is reproduced, the processing of FIG. 29 is executed, so that the L image obtained by reproducing the Base view video stream is output from the 2D correspondence reproducing apparatus 301. In the 2D correspondence display apparatus 302 that cannot display the stereoscopic image, the 2D image is displayed.

According to the PlayList file including each information described above, the MPEG-4 MVC video stream is reproduced by the 3D correspondence reproducing apparatus that can reproduce the MPEG-4 MVC video stream, so that the stereoscopic image can be output. In addition, only the Base view video stream is reproduced by the 2D correspondence reproducing apparatus that cannot reproduce the MPEG-4 MVC video stream, so that the 2D image can be output.

That is, it is possible to provide the PlayList file to reproduce the MPEG-4 MVC video stream, in a form in which compatibility is maintained such that the video stream can be reproduced by the reproducing apparatus corresponding to only the 2D reproduction.

### Modification

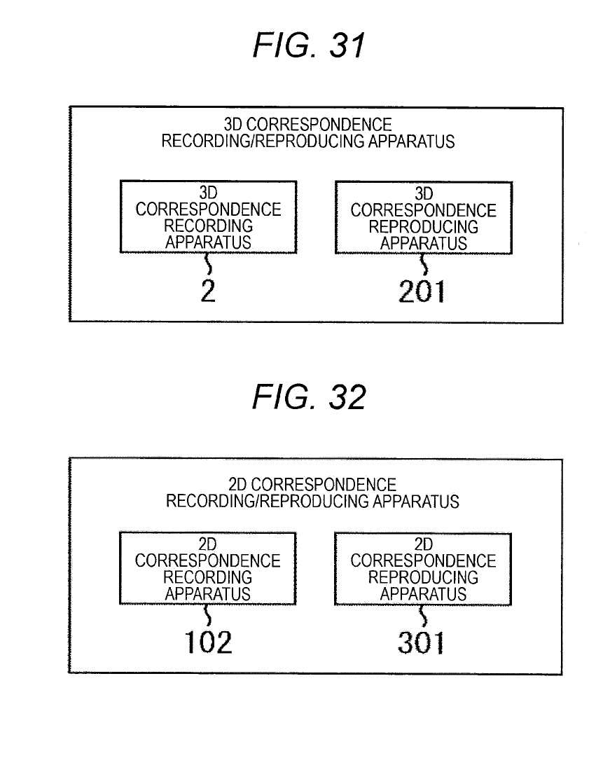

As illustrated in FIG. 31, the configurations of the 3D correspondence recording apparatus 2 and the 3D correspondence reproducing apparatus 201 are provided in one apparatus, so that a 3D correspondence recording/reproducing apparatus can be realized.

In addition, as illustrated in FIG. 32, the configurations of the 2D correspondence recording apparatus 102 and the 2D correspondence reproducing apparatus 301 are provided in one apparatus, so that a 2D correspondence recording/reproducing apparatus can be realized.

### [Configuration Example of Computer]

The series of processing described above can be executed by hardware and can be executed by software. When the series of processing is executed by the software, a program constituting the software is installed in a computer embedded in dedicated hardware or a general-purpose personal computer, from a program recording medium.

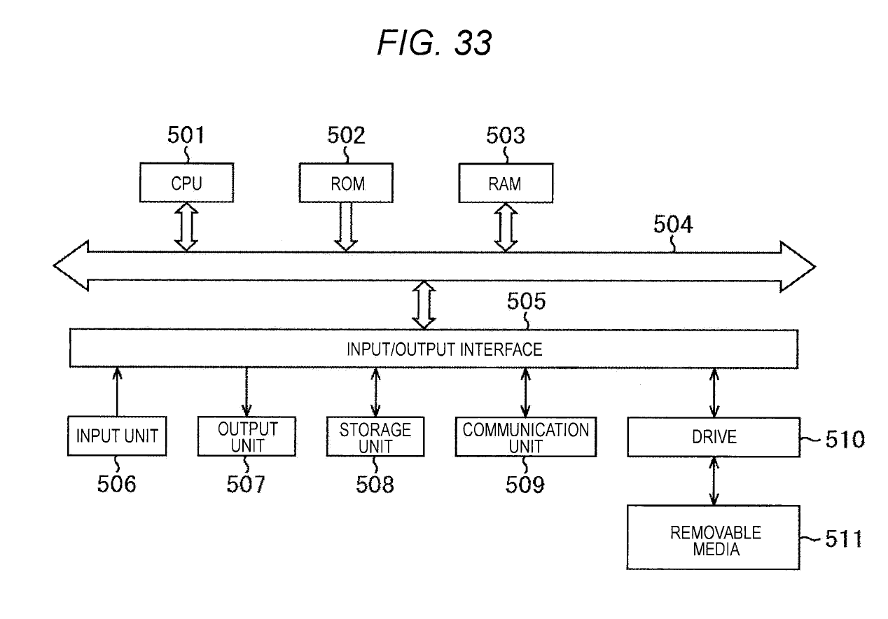

FIG. 33 is a block diagram illustrating a configuration example of hardware of a computer that executes the series of processing by a program.

A CPU (Central Processing Unit) 501, a ROM (Read Only Memory) 502, and a RAM (Random Access Memory) 503 are mutually connected by a bus 504.

An input/output interface 505 is connected to the bus 504. An input unit 506 including a keyboard and a mouse and an output unit 507 including a display and a speaker are connected to the input/output interface 505. In addition, a storage unit 508 including a hard disk or a non-volatile memory, a communication unit 509 including a network interface, and a drive 510 driving removable media 511 are connected to the input/output interface 505.

In the computer configured as described above, the CPU 501 loads a program stored in the storage unit 508 to the RAM 503 through the input/output interface 505 and the bus 504 and executes the program, so that the series of processing is executed.

The program that is executed by the CPU 501 is recorded on the removable media 511 or is provided through wired or wireless transmission media such as a local area network, the Internet, and digital broadcasting and is installed in the storage unit 508.

The program that is executed by the computer may be a program in which processing is executed in time series according to the order described in the present specification or may be a program in which processing is executed in parallel or at necessary timing such as when calling is performed.

The embodiments of the present technology are not limited to the embodiments described above and various changes can be made without departing from the scope of the present technology.

### [Combination Example of Configurations]

The present technology can take the following configurations.

(1)

A recording apparatus including:

a first generating unit that, as reproduction control information of a first video stream including a base stream obtained by encoding a predetermined image among a plurality of images having different viewing points and a dependent stream obtained by encoding other image, including a picture obtained by encoding a picture of the base stream as a reference image, generates information to which the same version information as version information of reproduction control information of a second video stream encoded using the same encoding method as an encoding method of the base stream is set; and

a recording control unit that records the first video stream and the reproduction control information of the first video stream on a recording medium.

(2)

The recording apparatus according to (1),

wherein the first video stream is an MPEG-4 MVC video stream, and

the second video stream is an MPEG-4 AVC video stream.

(3)

The recording apparatus according to (2), further including:

a second generating unit that generates a file including encoding information showing an encoding method of each of the base stream and the dependent stream,

wherein the recording control unit further records the file on the recording medium.

(4)

The recording apparatus according to (3),

wherein the reproduction control information is a PlayList file, and

the file is a Clip Information file that corresponds to a transport stream file including the MPEG-4 MVC video stream.

(5)

The recording apparatus according to (4),

wherein the second generating unit sets two video information including the encoding information to ProgramInfo( ) of the Clip Information file,

the second generating unit sets a value showing the encoding method of the base stream to the encoding information of the first video information, and

the second generating unit sets a value showing the encoding method of the dependent stream to the encoding information of the second video information.

(6)

The recording apparatus according to (5),

wherein the second generating unit sets a value showing that the base stream is an MPEG-4 AVC video stream or an MPEG-4 MVC Base view video stream, as the value showing the encoding method of the base stream, and

the second generating unit sets a value showing that the dependent stream is an MPEG-4 MVC Dependent view video stream, as the value showing the encoding method of the dependent stream.

(7)

The recording apparatus according to any of (4) to (6),

wherein the second generating unit sets the same information as version information of the PlayList file as version information of the Clip Information file.

(8)

The recording apparatus according to any of (1) to (7), further including:

an encoding unit that encodes the plurality of images with MPEG-4 MVC and generates the base stream and the dependent stream.

(9)

A recording method including:

as reproduction control information of a first video stream including a base stream obtained by encoding a predetermined image among a plurality of images having different viewing points and a dependent stream obtained by encoding other image, including a picture obtained by encoding a picture of the base stream as a reference image, generating information to which the same version information as version information of reproduction control information of a second video stream encoded using the same encoding method as an encoding method of the base stream is set; and

recording the first video stream and the reproduction control information of the first video stream on a recording medium.

(10)

A program for causing a computer to execute processing including:

as reproduction control information of a first video stream including a base stream obtained by encoding a predetermined image among a plurality of images having different viewing points and a dependent stream obtained by encoding other image, including a picture obtained by encoding a picture of the base stream as a reference image, generating information to which the same version information as version information of reproduction control information of a second video stream encoded using the same encoding method as an encoding method of the base stream is set; and

recording the first video stream and the reproduction control information of the first video stream on a recording medium.

(11)

A reproducing apparatus including:

a control unit that, according to a first video stream including a base stream obtained by encoding a predetermined image among a plurality of images having different viewing points and a dependent stream obtained by encoding other image, including a picture obtained by encoding a picture of the base stream as a reference image, and reproduction control information of the first video stream to which the same version information as version information of reproduction control information of a second video stream encoded using the same encoding method as an encoding method of the base stream is set and which is recorded on a recording medium, controls decoding of the first video stream; and

a decoding unit that decodes only the base stream or decodes both the base stream and the dependent stream, according to the control from the control unit.

(12)

The reproducing apparatus according to (11),

wherein the decoding unit that can decode the base stream and the dependent stream decodes the base stream and the dependent stream and outputs the predetermined image and other image.

(13)

The reproducing apparatus according to (11),

wherein the decoding unit that cannot decode the dependent stream decodes only the base stream and outputs the predetermined image.

(14)

A reproducing method including:

according to a first video stream including a base stream obtained by encoding a predetermined image among a plurality of images having different viewing points and a dependent stream obtained by encoding other image, including a picture obtained by encoding a picture of the base stream as a reference image, and reproduction control information of the first video stream to which the same version information as version information of reproduction control information of a second video stream encoded using the same encoding method as an encoding method of the base stream is set and which is recorded on a recording medium, decoding only the base stream or decoding both the base stream and the dependent stream.

(15)

A program for causing a computer to execute processing including:

according to a first video stream including a base stream obtained by encoding a predetermined image among a plurality of images having different viewing points and a dependent stream obtained by encoding other image, including a picture obtained by encoding a picture of the base stream as a reference image, and reproduction control information of the first video stream to which the same version information as version information of reproduction control information of a second video stream encoded using the same encoding method as an encoding method of the base stream is set and which is recorded on a recording medium, decoding only the base stream or decoding both the base stream and the dependent stream.

(16)

A recording/reproducing apparatus including:

a generating unit that, as reproduction control information of a first video stream including a base stream obtained by encoding a predetermined image among a plurality of images having different viewing points and a dependent stream obtained by encoding other image, including a picture obtained by encoding a picture of the base stream as a reference image, generates information to which the same version information as version information of reproduction control information of a second video stream encoded using the same encoding method as an encoding method of the base stream is set;

a recording control unit that records the first video stream and the reproduction control information of the first video stream on a recording medium;

a control unit that controls decoding of the first video stream, according to the reproduction control information of the first video stream recorded on the recording medium; and

a decoding unit that decodes only the base stream or decodes both the base stream and the dependent stream, according to the control from the control unit.

### REFERENCE SIGNS LIST

1 3D video camera
2 3D correspondence recording apparatus
3 Optical disk
101 2D video camera
102 2D correspondence recording apparatus
201 3D correspondence reproducing apparatus
202 3D correspondence display apparatus
301 2D correspondence reproducing apparatus
302 2D correspondence display apparatus

1. A recording apparatus comprising:
a first generating unit that, as reproduction control information of a first video stream including a base stream obtained by encoding a predetermined image among a plurality of images having different viewing points and a dependent stream obtained by encoding other image, including a picture obtained by encoding a picture of the base stream as a reference image, generates information to which the same version information as version information of reproduction control information of a second video stream encoded using the same encoding method as an encoding method of the base stream is set; and
a recording control unit that records the first video stream and the reproduction control information of the first video stream on a recording medium.

2. The recording apparatus according to claim 1,
wherein the first video stream is an MPEG-4 MVC video stream, and
the second video stream is an MPEG-4 AVC video stream.

3. The recording apparatus according to claim 2, further comprising:
a second generating unit that generates a file including encoding information showing an encoding method of each of the base stream and the dependent stream,
wherein the recording control unit further records the file on the recording medium.

4. The recording apparatus according to claim 3,
wherein the reproduction control information is a PlayList file, and
the file is a Clip Information file that corresponds to a transport stream file including the MPEG-4 MVC video stream.

5. The recording apparatus according to claim 4,
wherein the second generating unit sets two video information including the encoding information to ProgramInfo( ) of the Clip Information file,
the second generating unit sets a value showing the encoding method of the base stream to the encoding information of the first video information, and
the second generating unit sets a value showing the encoding method of the dependent stream to the encoding information of the second video information.

6. The recording apparatus according to claim 5,
wherein the second generating unit sets a value showing that the base stream is an MPEG-4 AVC video stream or an MPEG-4 MVC Base view video stream, as the value showing the encoding method of the base stream, and
the second generating unit sets a value showing that the dependent stream is an MPEG-4 MVC Dependent view video stream, as the value showing the encoding method of the dependent stream.

7. The recording apparatus according to claim 4,
wherein the second generating unit sets the same information as version information of the PlayList file as version information of the Clip Information file.

8. The recording apparatus according to claim 1, further comprising:
an encoding unit that encodes the plurality of images with MPEG-4 MVC and generates the base stream and the dependent stream.

9. A recording method comprising:
as reproduction control information of a first video stream including a base stream obtained by encoding a predetermined image among a plurality of images having different viewing points and a dependent stream obtained by encoding other image, including a picture obtained by encoding a picture of the base stream as a reference image, generating information to which the same version information as version information of reproduction control information of a second video stream encoded using the same encoding method as an encoding method of the base stream is set; and
recording the first video stream and the reproduction control information of the first video stream on a recording medium.

10. A program for causing a computer to execute processing including:
as reproduction control information of a first video stream including a base stream obtained by encoding a predetermined image among a plurality of images having different viewing points and a dependent stream obtained by encoding other image, including a picture obtained by encoding a picture of the base stream as a reference image, generating information to which the same version information as version information of reproduction control information of a second video stream encoded using the same encoding method as an encoding method of the base stream is set; and
recording the first video stream and the reproduction control information of the first video stream on a recording medium.

11. A reproducing apparatus comprising:
a control unit that, according to a first video stream including a base stream obtained by encoding a predetermined image among a plurality of images having different viewing points and a dependent stream obtained by encoding other image, including a picture obtained by encoding a picture of the base stream as a reference image, and reproduction control information of the first video stream to which the same version information as version information of reproduction control information of a second video stream encoded using the same encoding method as an encoding method of the base stream is set and which is recorded on a recording medium, controls decoding of the first video stream; and
a decoding unit that decodes only the base stream or decodes both the base stream and the dependent stream, according to the control from the control unit.

12. The reproducing apparatus according to claim 11,
wherein the decoding unit that can decode the base stream and the dependent stream decodes the base stream and the dependent stream and outputs the predetermined image and other image.

13. The reproducing apparatus according to claim 11,
wherein the decoding unit that cannot decode the dependent stream decodes only the base stream and outputs the predetermined image.

14. A reproducing method comprising:
according to a first video stream including a base stream obtained by encoding a predetermined image among a plurality of images having different viewing points and a dependent stream obtained by encoding other image, including a picture obtained by encoding a picture of the base stream as a reference image, and reproduction control information of the first video stream to which the same version information as version information of reproduction control information of a second video stream encoded using the same encoding method as an encoding method of the base stream is set and which is recorded on a recording medium, decoding only the base stream or decoding both the base stream and the dependent stream.

15. A program for causing a computer to execute processing including:
according to a first video stream including a base stream obtained by encoding a predetermined image among a plurality of images having different viewing points and a dependent stream obtained by encoding other image, including a picture obtained by encoding a picture of the base stream as a reference image, and reproduction control information of the first video stream to which the same version information as version information of reproduction control information of a second video stream encoded using the same encoding method as an encoding method of the base stream is set and which is recorded on a recording medium, decoding only the base stream or decoding both the base stream and the dependent stream.

16. A recording/reproducing apparatus comprising:
a generating unit that, as reproduction control information of a first video stream including a base stream obtained by encoding a predetermined image among a plurality of images having different viewing points and a dependent stream obtained by encoding other image, including a picture obtained by encoding a picture of the base stream as a reference image, generates information to which the same version information as version information of reproduction control information of a second video stream encoded using the same encoding method as an encoding method of the base stream is set;
a recording control unit that records the first video stream and the reproduction control information of the first video stream on a recording medium;
a control unit that controls decoding of the first video stream, according to the reproduction control information of the first video stream recorded on the recording medium; and
a decoding unit that decodes only the base stream or decodes both the base stream and the dependent stream, according to the control from the control unit.
